(19) United States
(12) Patent Application Publication
(10) Pub. No.: US 2025/0296472 A1
(43) Pub. Date: Sep. 25, 2025

(54) MODULARIZATION AND POWER MANAGEMENT OF BATTERY MODULES

(71) Applicant: ZERO NOX, INC., Porterville, CA (US)

(72) Inventors: Dale Chi-Don CHIU, Hsinchu (TW); Vonn Robert CHRISTENSON, Porterville, CA (US); Robert Thomas CRUESS, Porterville, CA (US); Zakary SMITH, La Jolla, CA (US); Jacob GOTBERG, Provo, UT (US); Ernest LEE, Provo, UT (US)

(21) Appl. No.: 18/863,321

(22) PCT Filed: May 4, 2023
(86) PCT No.: PCT/US2023/021077

§ 371 Date: Nov. 5, 2024

Related U.S. Application Data
(60) Provisional application No. 63/364,333, filed on May 6, 2022.
(60) Provisional application No. 63/368,593, filed on Jul. 15, 2022.

(51) Int. Cl. B60L 58/13; B60L 58/15; B60L 58/20; B60L 58/22; H02J 7/00

(52) U.S. Cl. CPC B60L 58/13; B60L 58/15; B60L 58/20; B60L 58/22; H02J 7/00034; H02J 7/0024; H02J 7/0031; H02J 7/0048; H02J 7/007182; B60L 2240/547

(57) ABSTRACT

A modular battery system can allow for a varying number of battery modules to be connected or disconnected to the system to meet the power needs of particular applications, such as in use in different electrical vehicles. The system can provide parallel or series connections between the battery modules to further meet the power needs of the particular applications. The system can charge the battery modules and manage charging to charge a lowest voltage state battery module to increase battery efficiency and longevity.

### CROSS-REFERENCE TO RELATED APPLICATIONS

This application claims priority to U.S. Provisional Patent Application 63/364,333 filed on May 6, 2022, entitled “STANDARDIZATION OF A NEW ENERGY VEHICLE POWER BATTERY MODULE,” and U.S. Provisional Patent Application 63/368,593 filed on Jul. 15, 2022, entitled “STANDARDIZATION OF A NEW ENERGY VEHICLE POWER BATTERY MODULE,” which are incorporated by reference herein in their entirety.

### BACKGROUND

### Field

This disclosure relates to a modularization and power management of battery modules.

### Description of the Related Art

With increasing energy demands and environmental problems related to pollution and global warming, electrification and batteries have been widely adopted in automobiles or other applications. The performance of battery modules affects the performance electric vehicles and other applications. Demands on batteries are becoming higher such as higher capacity, higher safety, lower internal resistance, faster conductivity, and replaceable battery modules.

### SUMMARY

Presently, battery systems are not modular and difficult to expand. With the increasing popularity of electrification such as in electric vehicles, standardization of battery modules is needed. Electric vehicles have been developing rapidly, but due to the non-uniform standards of various manufacturers, there are many kinds and sizes of battery modules on the market. Development, life-cycles, replacement, mass production of battery modules can be improved with standardization and modularity of the battery systems.

A modular battery system can include a power distribution unit, one or more battery module connectors, a fast-charging direct current (DC) connector, a slow-charging alternating current (AC) connector, a high voltage output connector, a vehicle communication interface, and an internal communication interface. The power distribution unit can include a battery management system to monitor and manage charging and discharging process. A module management unit can detect battery failures and transfer a signal to the battery management unit disconnect the power distribution unit from the one or more battery modules.

A power distribution unit can be used to provide and/or manage power to one or more components of an electric vehicle. The power distribution unit can include one or more connectors configured to electrically connect one or more modular batteries, a battery management unit to receive and provide communications to the one or more battery modules, a fast-charging connection port, and a slow-charging connection port. The battery management unit can detect the arrangement of the one or more battery modules and determine a state of charge of the combined one or more battery modules.

Battery balancing or self-balancing for parallel charging can be used to improve the health and longevity of battery modules and the overall performance of a system. The self-balancing process can identify whether the battery modules and/or battery cells of the battery modules are within a voltage range. If the battery modules and/or cells are outside of the predetermined range, the lowest voltage battery module and/or cell can be charged to a complete state of charge. By identifying the lowest voltage battery module and charging said battery first, the battery modules in parallel can be charged without being overcharging, thus preventing additional degradation. Once the battery modules and/or cells are of a similar voltage, the battery modules and/or cells can be simultaneously charged. Battery balancing during charging of a varying number of battery modules, as well as other charging protocols such fast and/or fast charging, can be used to provide modularity by allowing a varying number of battery modules to be connected to the system that are managed, charged, and discharged by the systems and methods disclosed herein.

In some aspects, the techniques described herein relate to a vehicle modular battery system configured to charge at least two battery modules, the system including: at least two battery modules each including a plurality of battery cells configured to store electric energy; a power distribution unit including: a first electrical interface configured to connect to an external energy source for delivering electric power to the power distribution unit from the external energy source; a second electrical interface configured to connect to an electric motor of a vehicle for delivering electric power to the electric motor from the power distribution unit; and a third electrical interface configured to connect to the at least two battery modules for delivering electric power to the at least two battery modules from the power distribution unit and delivering electric power to the power distribution unit from the at least two battery modules; a non-transitory memory configured to store specific computer-executable instructions; and a hardware processor in communication with the non-transitory memory and configured to execute the specific computer-executable instructions to at least: determine that the at least two battery modules are within a first voltage range of each other; in response to determining that the at least two battery modules are within the first voltage range of each other, cause the power distribution unit to charge the at least two battery modules to a 100% state of charge using electric power from the external energy source; determine that the at least two battery modules are not within the first voltage range of each other; in response to determining that the at least two battery modules are not within the first voltage range of each other, determine that the at least two battery modules are not within a second voltage range of each other, the second voltage range greater than the first voltage range; in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source; determine that the at least two battery modules are within the second voltage range of each other; and in response to determining that the at least two battery modules are within the second voltage range of each other, cause the power distribution unit to charge the at least two battery modules using electric power from the external energy source to change states of the at least two battery modules to be within the first voltage range of each other.

In some aspects, the techniques described herein relate to a system, wherein the at least two battery modules include at least three battery modules, and wherein the hardware processor is further configured to execute the specific computer-executable instructions to at least, in response to determining that the at least two battery modules are within the second voltage range of each other, cause the power distribution unit to charge at least a first and a second battery module of the at least three battery modules using electric power from the external energy source to change states of the at least three battery modules to be within the first voltage range of each other.

In some aspects, the techniques described herein relate to a system, wherein the at least the first and the second battery module have lowest voltages relative to the other battery modules of the at least three battery modules.

In some aspects, the techniques described herein relate to a system, wherein the at least two battery modules are connected to the power distribution unit in parallel.

In some aspects, the techniques described herein relate to a system, wherein the power distribution unit is configured to switch connection of the at least two battery modules between parallel electrical connection or series electrical connection to the power distribution unit.

In some aspects, the techniques described herein relate to a system, wherein the power distribution unit further includes a fourth electrical interface configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a system, wherein the first electrical interface is configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a system, wherein the external energy source includes at least one of a fast-charging source or a slow-charging source.

In some aspects, the techniques described herein relate to a system, wherein the fast-charging source includes a direct current energy source and the slow-charging source includes an alternating current source.

In some aspects, the techniques described herein relate to a system, wherein the hardware processor is further configured to execute the specific computer-executable instructions to at least determine whether the fast-charging source or the slow-charging source is connected to the first electrical interface.

In some aspects, the techniques described herein relate to a system, wherein the second electrical interface is configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a system, wherein the power distribution unit further includes a fifth electrical interface configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a system, wherein the second or fifth electrical interface is configured to communicate with a motor controller to receive the electric motor data, the motor controller configured to control operation of the electric motor.

In some aspects, the techniques described herein relate to a system, wherein the third electrical interface is configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a system, wherein the power distribution unit further includes a sixth electrical interface configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a system, wherein the third or sixth electrical interface is configured to communicate with a module management unit to receive the battery module data, the module management unit configured to control operation of one of the at least two battery modules.

In some aspects, the techniques described herein relate to a system, wherein the hardware processor is further configured to execute the specific computer-executable instructions to at least receive a charging connection signal from each of the at least two battery modules indicating that the at least two battery modules are ready to be charged.

In some aspects, the techniques described herein relate to a system, wherein the hardware processor is further configured to execute the specific computer-executable instructions to at least: receive a charging port signal from the external energy source; determine a pulse-width modulation and duty cycle from the charging port signal; and determine a maximum charging current to be delivered by the external energy source from the pulse-width modulation and duty cycle.

In some aspects, the techniques described herein relate to a system, wherein the hardware processor is further configured to execute the specific computer-executable instructions to at least determine whether to charge the at least two battery modules using a fast-charging protocol or a slow-charging protocol based on the pulse-width modulation and duty cycle.

In some aspects, the techniques described herein relate to a system, wherein the hardware processor is further configured to execute the specific computer-executable instructions to at least determine to charge the at least two battery modules using the fast-charging protocol based on a duty cycle of 3% to 7%.

In some aspects, the techniques described herein relate to a system, wherein the hardware processor is further configured to execute the specific computer-executable instructions to at least determine to charge the at least two battery modules using the slow-charging protocol based on a duty cycle of 8% to 97%.

In some aspects, the techniques described herein relate to a system, wherein the external energy source includes at least two external energy sources, wherein the first electrical interface includes at least two electrical interfaces, wherein each of the at least two electrical interfaces are configured to connect to a corresponding external energy source of the at least two external energy sources.

In some aspects, the techniques described herein relate to a system, wherein the at least two external energy sources include a direct current charging source and an alternating current charging source.

In some aspects, the techniques described herein relate to a system, wherein the third electrical interface includes at least two electrical interfaces, wherein each of the at least two electrical interfaces are configured to connect to a corresponding battery module of the at least two battery modules.

In some aspects, the techniques described herein relate to a system, wherein the third electrical interface is configured to connect to a varying number of battery modules of the at least two battery modules.

In some aspects, the techniques described herein relate to a system, wherein the hardware processor is further configured to execute the specific computer-executable instructions to at least determine a number of battery modules of the at least two battery modules connected to the third electrical interface.

In some aspects, the techniques described herein relate to a system, wherein the first voltage range is the at least two battery modules being within 0.1 volts of each other.

In some aspects, the techniques described herein relate to a system, wherein the second voltage range is the at least two battery modules being within 0.2 volts of each other.

In some aspects, the techniques described herein relate to a modular battery system configured to charge at least two battery modules, the system including: at least two battery modules each including a plurality of battery cells configured to store electric energy; a power distribution unit including: a first electrical interface configured to connect to an external energy source for delivering electric power to the power distribution unit from the external energy source; and a second electrical interface configured to connect to the at least two battery modules for delivering electric power to the at least two battery modules from the power distribution unit and delivering electric power to the power distribution unit from the at least two battery modules; a non-transitory memory configured to store specific computer-executable instructions; and a hardware processor in communication with the non-transitory memory and configured to execute the specific computer-executable instructions to at least: determine that the at least two battery modules are within a first voltage range of each other; in response to determining that the at least two battery modules are within the first voltage range of each other, cause the power distribution unit to charge the at least two battery modules to a 100% state of charge using electric power from the external energy source; determine that the at least two battery modules are not within the first voltage range of each other; in response to determining that the at least two battery modules are not within the first voltage range of each other, determine that the at least two battery modules are not within a second voltage range of each other, the second voltage range greater than the first voltage range; in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source; determine that the at least two battery modules are within the second voltage range of each other; and in response to determining that the at least two battery modules are within the second voltage range of each other, cause the power distribution unit to charge the at least two battery modules using electric power from the external energy source to change states of the at least two battery modules to be within the first voltage range of each other.

In some aspects, the techniques described herein relate to a system, wherein the at least two battery modules include at least three battery modules, and wherein the hardware processor is further configured to execute the specific computer-executable instructions to at least, in response to determining that the at least two battery modules are within the second voltage range of each other, cause the power distribution unit to charge at least a first and a second battery module of the at least three battery modules using electric power from the external energy source to change states of the at least three battery modules to be within the first voltage range of each other.

In some aspects, the techniques described herein relate to a system, wherein the at least the first and the second battery module have lowest voltages relative to the other battery modules of the at least three battery modules.

In some aspects, the techniques described herein relate to a system, wherein the at least two battery modules are connected to the power distribution unit in parallel.

In some aspects, the techniques described herein relate to a system, wherein the power distribution unit is configured to switch connection of the at least two battery modules between parallel electrical connection or series electrical connection to the power distribution unit.

In some aspects, the techniques described herein relate to a system, wherein the power distribution unit further includes a third electrical interface configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a system, wherein the first electrical interface is configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a system, wherein the external energy source includes at least one of a fast-charging source or a slow-charging source.

In some aspects, the techniques described herein relate to a system, wherein the fast-charging source includes a direct current energy source and the slow-charging source includes an alternating current source.

In some aspects, the techniques described herein relate to a system, wherein the hardware processor is further configured to execute the specific computer-executable instructions to at least determine whether the fast-charging source or the slow-charging source is connected to the first electrical interface.

In some aspects, the techniques described herein relate to a system, wherein the second electrical interface is configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a system, wherein the power distribution unit further includes a fourth electrical interface configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a system, wherein the second or fourth electrical interface is configured to communicate with a module management unit to receive the battery module data, the module management unit configured to control operation of one of the at least two battery modules.

In some aspects, the techniques described herein relate to a system, wherein the hardware processor is further configured to execute the specific computer-executable instructions to at least receive a charging connection signal from each of the at least two battery modules indicating that the at least two battery modules are ready to be charged.

In some aspects, the techniques described herein relate to a system, wherein the hardware processor is further configured to execute the specific computer-executable instructions to at least: receive a charging port signal from the external energy source; determine a pulse-width modulation and duty cycle from the charging port signal; and determine a maximum charging current to be delivered by the external energy source from the pulse-width modulation and duty cycle.

In some aspects, the techniques described herein relate to a system, wherein the hardware processor is further configured to execute the specific computer-executable instructions to at least determine whether to charge the at least two battery modules using a fast-charging protocol or a slow-charging protocol based on the pulse-width modulation and duty cycle.

In some aspects, the techniques described herein relate to a system, wherein the hardware processor is further configured to execute the specific computer-executable instructions to at least determine to charge the at least two battery modules using the fast-charging protocol based on a duty cycle of 3% to 7%.

In some aspects, the techniques described herein relate to a system, wherein the hardware processor is further configured to execute the specific computer-executable instructions to at least determine to charge the at least two battery modules using the slow-charging protocol based on a duty cycle of 8% to 97%.

In some aspects, the techniques described herein relate to a system, wherein the external energy source includes at least two external energy sources, wherein the first electrical interface includes at least two electrical interfaces, wherein each of the at least two electrical interfaces are configured to connect to a corresponding external energy source of the at least two external energy sources.

In some aspects, the techniques described herein relate to a system, wherein the at least two external energy sources include a direct current charging source and an alternating current charging source.

In some aspects, the techniques described herein relate to a system, wherein the second electrical interface includes at least two electrical interfaces, wherein each of the at least two electrical interfaces are configured to connect to a corresponding battery module of the at least two battery modules.

In some aspects, the techniques described herein relate to a system, wherein the second electrical interface is configured to connect to a varying number of battery modules of the at least two battery modules.

In some aspects, the techniques described herein relate to a system, wherein the hardware processor is further configured to execute the specific computer-executable instructions to at least determine a number of battery modules of the at least two battery modules connected to the second electrical interface.

In some aspects, the techniques described herein relate to a system, wherein the first voltage range is the at least two battery modules being within 0.1 volts of each other.

In some aspects, the techniques described herein relate to a system, wherein the second voltage range is the at least two battery modules being within 0.2 volts of each other.

In some aspects, the techniques described herein relate to a system, wherein the power distribution unit further includes a fifth electrical interface configured to connect to an electric motor of a vehicle for delivering electric power to the electric motor from the power distribution unit.

In some aspects, the techniques described herein relate to a system, wherein the fifth electrical interface is configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a system, wherein the power distribution unit further includes a sixth electrical interface configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a system, wherein the fifth or sixth electrical interface is configured to communicate with a motor controller to receive the electric motor data, the motor controller configured to control operation of the electric motor.

In some aspects, the techniques described herein relate to a power distribution unit configured to charge at least two battery modules, the power distribution unit including: a first electrical interface configured to connect to an external energy source for delivering electric power to the power distribution unit from the external energy source; a second electrical interface configured to connect to at least two battery modules for delivering electric power to the at least two battery modules from the power distribution unit and delivering electric power to the power distribution unit from the at least two battery modules, the at least two battery modules each including a plurality of battery cells configured to store electric energy; a non-transitory memory configured to store specific computer-executable instructions; and a hardware processor in communication with the non-transitory memory and configured to execute the specific computer-executable instructions to at least: determine that the at least two battery modules are within a first voltage range of each other; and in response to determining that the at least two battery modules are within the first voltage range of each other, cause the power distribution unit to charge the at least two battery modules to a 100% state of charge using electric power from the external energy source.

In some aspects, the techniques described herein relate to a power distribution unit, wherein the at least two battery modules include at least three battery modules, and wherein the hardware processor is further configured to execute the specific computer-executable instructions to at least, in response to determining that the at least two battery modules are within the second voltage range of each other, cause the power distribution unit to charge at least a first and a second battery module of the at least three battery modules using electric power from the external energy source to change states of the at least three battery modules to be within the first voltage range of each other.

In some aspects, the techniques described herein relate to a power distribution unit, wherein the at least the first and the second battery module have lowest voltages relative to the other battery modules of the at least three battery modules.

In some aspects, the techniques described herein relate to a power distribution unit, wherein the at least two battery modules are connected to the power distribution unit in parallel.

In some aspects, the techniques described herein relate to a power distribution unit, wherein the second electrical interface is configured to switch connection of the at least two battery modules between parallel electrical connection or series electrical connection to the power distribution unit.

In some aspects, the techniques described herein relate to a power distribution unit, further including a third electrical interface configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a power distribution unit, wherein the first electrical interface is configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

In some aspects, the techniques described herein relate to a power distribution unit, wherein the external energy source includes at least one of a fast-charging source or a slow-charging source.

In some aspects, the techniques described herein relate to a power distribution unit, wherein the fast-charging source includes a direct current energy source and the slow-charging source includes an alternating current source.

In some aspects, the techniques described herein relate to a power distribution unit, wherein the hardware processor is further configured to execute the specific computer-executable instructions to at least determine whether the fast-charging source or the slow-charging source is connected to the first electrical interface.

In some aspects, the techniques described herein relate to a power distribution unit, wherein the second electrical interface is configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a power distribution unit, further including a fourth electrical interface configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data.

In some aspects, the techniques described herein relate to a power distribution unit, wherein the second or fourth electrical interface is configured to communicate with a module management unit to receive the battery module data, the module management unit configured to control operation of one of the at least two battery modules.

In some aspects, the techniques described herein relate to a power distribution unit, wherein the hardware processor is further configured to execute the specific computer-executable instructions to at least receive a charging connection signal from each of the at least two battery modules indicating that the at least two battery modules are ready to be charged.

In some aspects, the techniques described herein relate to a power distribution unit, wherein the hardware processor is further configured to execute the specific computer-executable instructions to at least: receive a charging port signal from the external energy source; determine a pulse-width modulation and duty cycle from the charging port signal; and determine a maximum charging current to be delivered by the external energy source from the pulse-width modulation and duty cycle.

In some aspects, the techniques described herein relate to a power distribution unit, wherein the hardware processor is further configured to execute the specific computer-executable instructions to at least determine whether to charge the at least two battery modules using a fast-charging protocol or a slow-charging protocol based on the pulse-width modulation and duty cycle.

In some aspects, the techniques described herein relate to a power distribution unit, wherein the hardware processor is further configured to execute the specific computer-executable instructions to at least determine to charge the at least two battery modules using the fast-charging protocol based on a duty cycle of 3% to 7%.

In some aspects, the techniques described herein relate to a power distribution unit, wherein the hardware processor is further configured to execute the specific computer-executable instructions to at least determine to charge the at least two battery modules using the slow-charging protocol based on a duty cycle of 8% to 97%.

In some aspects, the techniques described herein relate to a power distribution unit, wherein the external energy source includes at least two external energy sources, wherein the first electrical interface includes at least two electrical interfaces, wherein each of the at least two electrical interfaces are configured to connect to a corresponding external energy source of the at least two external energy sources.

In some aspects, the techniques described herein relate to a power distribution unit, wherein the at least two external energy sources include a direct current charging source and an alternating current charging source.

In some aspects, the techniques described herein relate to a power distribution unit, wherein the second electrical interface includes at least two electrical interfaces, wherein each of the at least two electrical interfaces are configured to connect to a corresponding battery module of the at least two battery modules.

In some aspects, the techniques described herein relate to a power distribution unit, wherein the second electrical interface is configured to connect to a varying number of battery modules of the at least two battery modules.

In some aspects, the techniques described herein relate to a power distribution unit, wherein the hardware processor is further configured to execute the specific computer-executable instructions to at least determine a number of battery modules of the at least two battery modules connected to the second electrical interface.

In some aspects, the techniques described herein relate to a power distribution unit, wherein the first voltage range is the at least two battery modules being within 0.1 volts of each other.

In some aspects, the techniques described herein relate to a power distribution unit, further including a fifth electrical interface configured to connect to an electric motor of a vehicle for delivering electric power to the electric motor from the power distribution unit.

In some aspects, the techniques described herein relate to a power distribution unit, wherein the fifth electrical interface is configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a power distribution unit, further including a sixth electrical interface configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data.

In some aspects, the techniques described herein relate to a power distribution unit, wherein the fifth or sixth electrical interface is configured to communicate with a motor controller to receive the electric motor data, the motor controller configured to control operation of the electric motor.

In some aspects, the techniques described herein relate to a power distribution unit, wherein the hardware processor is further configured to execute the specific computer-executable instructions to at least: determine that the at least two battery modules are not within the first voltage range of each other; in response to determining that the at least two battery modules are not within the first voltage range of each other, determine that the at least two battery modules are not within a second voltage range of each other, the second voltage range greater than the first voltage range; in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source; determine that the at least two battery modules are within the second voltage range of each other; and in response to determining that the at least two battery modules are within the second voltage range of each other, cause the power distribution unit to charge the at least two battery modules using electric power from the external energy source to change states of the at least two battery modules to be within the first voltage range of each other.

In some aspects, the techniques described herein relate to a power distribution unit, wherein the second voltage range is the at least two battery modules being within 0.2 volts of each other.

In some aspects, the techniques described herein relate to a vehicle modular battery system of an electric vehicle configured to charge two or more battery modules, the system including: a power distribution unit including: a first electrical interface configured to connect to an external energy source; a second electrical interface configured to connect to at least two battery modules; and a third electrical interface configured to connect to a motor controller of the electric vehicle; the at least two battery modules each including a plurality of battery cells configured to deliver electrical power to an electric motor of the vehicle; wherein a battery management system is configured to: detect a charging signal; determine that the plurality of battery cells of each of the one or more battery modules are within 0.1 volts of each other; in response to determining that the plurality of battery cells of each of the one or more battery modules are within 0.1 volts of the other plurality of battery cells of the other one or more battery modules, cause the battery management system to charge the plurality of battery cells of all of the one or more battery modules to a 100% state of charge; determine that the plurality of battery cells of each of the one or more battery modules are not within 0.1 volts of each other; in response to determining that the plurality of battery cells of each of the one or more battery modules are not within 0.1 volts of the other plurality of battery cells of the other one or more battery modules, determine whether the plurality of battery cells of each of the one or more battery modules are within 0.2 volts of the other plurality of battery cells of the other one or more battery modules; in response to determining that the plurality of battery cells of each the one or more battery modules are not within 0.2 volts of the other plurality of battery cells of the other one or more battery modules, open one or more charging relays to all but a determined lowest voltage battery module of the one or more battery modules and charge the lowest voltage battery module to 100% state of charge; determine that the plurality of battery cells of each the one or more battery modules are within 0.2 volts of the other plurality of battery cells of the other one or more battery modules; in response to determining that the plurality of battery cells of each the one or more battery modules are within 0.2 volts of the other plurality of battery cells of the other one or more battery modules, cause the battery management system to self-balance the plurality of battery cells of the one or more battery modules within 0.1 volts of each other.

In some aspects, the techniques described herein relate to a system, wherein the power distribution unit is connected to the one or more battery modules in series.

In some aspects, the techniques described herein relate to a system, wherein the power distribution unit is connected to the one or more battery modules in parallel.

In some aspects, the techniques described herein relate to a system, wherein the power distribution unit is in electrical communication with a motor controller, the motor controller is configured to provide an interface between the power distribution unit and an electric motor.

In some aspects, the techniques described herein relate to a system, wherein the battery management system further includes a module management unit configured to monitor parameters of the plurality of battery cells, wherein the power distribution unit is further configured to detect a battery failure from any one of the one or more battery modules based on a battery failure level signal from the module management unit, wherein the module management unit transmits the battery failure level signal to the power distribution unit and sets an allowable discharge current from the one or more battery modules to the power distribution unit to zero amperes, wherein the battery management system triggers a timer before disconnecting the one or more battery modules from the power distribution unit, and wherein the battery management unit disconnects from the power distribution unit after the timer lapses and cuts off all power.

In some aspects, the techniques described herein relate to a system, wherein the battery management system is configured to perform a self-test to determine whether the charging source possesses a proper charging protocol.

In some aspects, the techniques described herein relate to a system, wherein the battery management system is further configured to determine that the one or more battery modules are in a parallel configuration or in a series configuration.

In some aspects, the techniques described herein relate to a system, further including an electric vehicle charging controller in communication with the battery management system, the electric vehicle charging controller configured to: accept a charging port signal from a charging source; communicate the charging port signal to the battery management system, wherein the battery management system sends a charging connection signal to begin charging the one or more battery modules; determine a pulse-width modulation and duty cycle of the charging signal for determining a maximum charging current by the charging source; and in response to determining the pulse-width modulation and duty cycle of the charging signal, communicate a fast-charging signal or slow-charging signal to the battery management system based at least on the pulse-width modulation and duty cycle; wherein the battery management system is further configured to, in response to receiving a charging connection signal from the electric vehicle communication controller: determine if a communication protocol and a charging mode are met; in response to determining that the communication and the charging mode are met, cause the power distribution unit to: close one or more charging relays and communicate a charging demand; and determine if the charging demands are met and disconnect from the charging source.

In some aspects, the techniques described herein relate to a system, wherein the fast-charging signal corresponds to a duty cycle of 3% to 7%.

In some aspects, the techniques described herein relate to a system, wherein the slow-charging signal corresponds to a duty cycle of 8% to 97%.

In some aspects, the techniques described herein relate to a system, wherein the battery management system is further configured to perform a self-test to determine whether a fast-charging protocol signal and/or a slow-charging protocol signal is detected from the charging connection signal.

In some aspects, the techniques described herein relate to a system, further including one or more pre-charge relays and one or more pre-charge resistors, wherein the one or more pre-charge relays are closed upon detecting the fast-charging protocol signal to gradually charge one or more capacitors of the power distribution unit, the gradual charging of the capacitors protecting the one or more battery modules from damage, and wherein the one or more pre-charge resistors limit an amount of current that flows into the capacitors.

In some aspects, the techniques described herein relate to a modular battery system for an electric vehicle, wherein the system includes: a power distribution unit configured to monitor and control a charging process of the battery module system, the power distribution unit having at least one or more battery connectors, a fast-charging port, a slow-charging port, a vehicle communication port interface, or an internal communication interface; one or more battery modules in electrical communication with the power distribution unit at the one or more battery connectors, wherein each of the one or more battery modules include: a plurality of battery cells; a module management unit configured to monitor parameters of the plurality of battery cells and manage the plurality of battery cells; and a battery management system in communication with the module management unit, the battery management unit configured to receive one or more parameters from the module management unit and to monitor a charging and discharging process of the plurality of battery cells; an electric vehicle charging controller in communication with the battery management system, the electric vehicle charging controller configured to at least: accept a charging port signal from a charging source; communicate the charging port signal to the battery management system, wherein the battery management system then sends a charging connection signal to begin charging the one or more battery modules; determine a pulse-width modulation and duty cycle of the charging signal for determining a maximum charging current by the charging source; and in response to determining the pulse-width modulation and duty cycle of the charging signal, communicate a fast-charging or slow-charging signal to the battery management system based at least on the pulse-width modulation and duty cycle; wherein the battery management system is further configured to, in response to receiving a charging connection signal from the electric vehicle communication controller: determine if a communication protocol and a charging mode are met; in response to determining that the communication and the charging mode are met, causing the power distribution unit to: close one or more charging relays and communicate a charging demand; and determine if the charging demands are met and exit the charging process.

In some aspects, the techniques described herein relate to a system, wherein the power distribution unit is connected to the one or more battery modules in series.

In some aspects, the techniques described herein relate to a system, wherein the power distribution unit is connected to the one or more battery modules in parallel.

In some aspects, the techniques described herein relate to a system, wherein the power distribution unit is in electrical communication with a motor controller, the motor controller is configured to provide an interface between the power distribution unit and an electric motor.

In some aspects, the techniques described herein relate to a system, wherein the battery management system is further configured to self-balance the one or more battery modules to at least: determine that all of the plurality of battery cells of each of the one or more battery modules are within 0.1 volts of each other; in response to determining that all of the plurality of battery cells of each of the one or more battery modules are within 0.1 volts of each other, cause the battery management system to charge all of the plurality of battery cells to a 100% state of charge.

In some aspects, the techniques described herein relate to a system, wherein the battery management system is further configured to self-balance the one or more battery modules to at least: determine that all of the plurality of battery cells of each of the one or more battery modules are not within 0.1 volts of each other; in response to determining that all of the plurality of battery cells of each of the one or more battery modules are not within 0.1 volts of each other, cause the battery management system to determine that all of the plurality of battery cells of each the one or more battery modules are within 0.2 volts of each other; in response to determining that all of the plurality of battery cells of each of the one or more battery modules are not within 0.2 volts of each other, cause the power distribution unit to open the charging relays to all but a determined lowest voltage battery module of the one or more battery modules and charge the determined lowest voltage battery module to 100% state of charge; determine that all of the plurality of battery cells of each the one or more battery modules are within 0.2 volts of each other; in response to determining that all of the plurality of battery cells of each of the one or more battery modules are within 0.2 volts of each other, cause the battery management system to self-balance the plurality of battery cells of the one or more battery modules within 0.1 volts of each other.

In some aspects, the techniques described herein relate to a system, wherein the module management system is further configured to detect a battery failure unit from any one of the one or more battery modules, wherein the module management system transmits a battery failure level to the battery management unit and set an allowable discharge current from the one or more battery modules to zero amperes, wherein the battery management system triggers a timer before disconnecting the one or more battery modules from the power distribution unit, wherein the battery management unit disconnects from the power distribution unit after the timer lapses and cuts off all power.

In some aspects, the techniques described herein relate to a system, wherein the battery management system is configured to perform a self-test to determine whether the charging source possesses a proper charging protocol.

In some aspects, the techniques described herein relate to a system, wherein the battery management system is further configured to determine that the one or more battery modules are in a parallel configuration or in a series configuration.

In some aspects, the techniques described herein relate to a system, wherein the fast-charging signal corresponds to a duty cycle of 3% to 7%.

In some aspects, the techniques described herein relate to a system, wherein the slow-charging signal corresponds to a duty cycle of 8% to 97%.

In some aspects, the techniques described herein relate to a system, wherein the battery management system is further configured to performs a self-test to determine whether a proper fast-charging protocol signal and/or slow-charging protocol signal is detected from the charging connection signal.

In some aspects, the techniques described herein relate to a system, further including one or more pre-charge relays and one or more pre-charge resistors, wherein the one or more pre-charge relays are closed upon detecting a proper fast-charging protocol signal to gradually charge one or more capacitors of the power distribution unit, the gradual charging of the capacitors protecting the one or more battery modules from damage, and wherein the one or more pre-charge resistors limit an amount of current that flows into the capacitors.

In some aspects, the techniques described herein relate to a power distribution unit for an electric vehicle, the power distribution unit including: one or more battery connectors configured to electrically communicate to one or more battery modules in an arrangement, the battery modules including a battery management system, a module management unit, a plurality of cells, and an internal communication interface; a direct current fast-charging connection port, the direct current fast-charging connection port configured to provide higher voltage charging to the one or more battery modules; an alternating current slow-charging connection port, the alternating current slow-charging connection port configured to provide lower voltage charging to the one or more battery modules; a vehicle communication interface, wherein the vehicle communication interface is configured to communicate with one or more components of the electric vehicle and a charging source; and an internal communication interface, wherein the internal communication is configured to communication with a battery management system of each of the one or more battery modules, and a battery management unit configured to monitor one or more parameters of the plurality of battery cells in each of the one or more battery modules to determine when the plurality of battery cells are balanced during charging and discharging.

In some aspects, the techniques described herein relate to a power distribution unit, wherein the one or more battery modules are connected to the one or more battery connectors in parallel.

In some aspects, the techniques described herein relate to a power distribution unit, wherein the one or more battery modules are connected to the one or more battery connectors in series.

In some aspects, the techniques described herein relate to a power distribution unit, wherein the battery management unit is further configured to detect a change in the arrangement of the one or more battery modules.

In some aspects, the techniques described herein relate to a power distribution unit, where in the change includes adding or subtracting a battery module from the arrangement of the one or more battery modules.

In some aspects, the techniques described herein relate to a power distribution unit, wherein the battery management unit is further configured to determine a state of charge based at least on the change in the arrangement of the one or more battery modules.

In some aspects, the techniques described herein relate to a power distribution unit, wherein the battery management unit is configured to detect the change in the arrangement of the one or more battery modules during a wake-up state.

In some aspects, the techniques described herein relate to a power distribution unit, wherein the battery management unit is configured to detect the change from switching the one or more battery modules from a parallel configuration to a series configuration.

In some aspects, the techniques described herein relate to a power distribution unit, wherein the battery management unit is configured to detect the change from switching the one or more battery modules from a series configuration to a parallel configuration.

In some aspects, the techniques described herein relate to a method of charging a modular battery system, the method including: accepting a charging port signal from a charging source; communicating the charging port signal to a battery management system, wherein the battery management system then sends a charging connection signal to begin charging one or more battery modules; determining a pulse-width modulation and duty cycle of the charging signal for determining a maximum charging current of a charging source; and in response to determining the pulse-width modulation and duty cycle of the charging signal, communicating a fast-charging or slow-charging signal to the battery management system based at least on the pulse-width modulation and duty cycle; determining if a communication protocol and a charging mode are met in response to receiving a charging connection signal from an electric vehicle communication controller; in response to determining that the communication and the charging mode are met, closing one or more charging relays and communicate a charging demand; and determining if the charging demands are met and disconnect from the charging source.

In some aspects, the techniques described herein relate to a method, further including: self-balance the one or more battery modules by: determining that a plurality of battery cells of each of one or more battery modules are within 0.1 volts of each other; in response to determining that the plurality of battery cells of each of the one or more battery modules are within 0.1 volts of each other, causing the battery management system to charge the plurality of battery cells to a 100% state of charge.

In some aspects, the techniques described herein relate to a method, further including: self-balancing the one or more battery modules by: determining that a plurality of battery cells of each of one or more battery modules are not within 0.1 volts of each other; in response to determining that the plurality of battery cells of each of the one or more battery modules are not within 0.1 volts of each other, determining that the plurality of battery cells of each the one or more battery modules are within 0.2 volts of each other; in response to determining that the plurality of battery cells of each the one or more battery modules are not within 0.2 volts of each other, opening the charging relays to all but a determined lowest voltage battery module of the one or more battery modules and charge the determined lowest voltage battery module to 100% state of charge; determining that the plurality of battery cells of each the one or more battery modules are within 0.2 volts of each other; in response to determining that the plurality of battery cells of each the one or more battery modules are within 0.2 volts of each other, self-balancing the plurality of battery cells of each of the one or more battery modules within 0.1 volts of each other.

Methods of using the system(s) (including device(s), apparatus(es), assembly(ies), structure(s), and/or the like) disclosed herein are included; the methods of use can include using or assembling any one or more of the features disclosed herein to achieve functions and/or features of the system(s) as discussed in this disclosure. Methods of manufacturing the system(s) disclosed herein are included; the methods of manufacture can include providing, making, connecting, assembling, and/or installing any one or more of the features of the system(s) disclosed herein to achieve functions and/or features of the system(s) as discussed in this disclosure.

Neither the preceding summary nor the following detailed description purports to limit or define the scope of protection. The scope of protection is defined by the claims.

### BRIEF DESCRIPTION OF THE DRAWINGS

FIG. 1 illustrates an example block diagram of a modular battery system that of an electric vehicle.

FIGS. 2A-2D illustrate perspective views of a two-way subsystem connection power distribution unit.

FIGS. 3A-3D illustrate perspective views of a four-way subsystem power distribution unit.

FIGS. 4A and 4B illustrate perspective views of a battery module used in two-way or four-way parallel or series.

FIGS. 5A-5C illustrate schematic views of an exemplary battery module.

FIGS. 6 and 7 illustrate the battery module of FIGS. 5A-5C connected with a power distribution unit.

FIGS. 8A and 8B illustrates sectional views of any of the power distribution unit of FIGS. 1-3D.

FIG. 9A illustrates a schematic diagram layout of the power distribution unit described in FIGS. 1-8B connected to one or more battery modules in series.

FIG. 9B illustrates a schematic diagram layout of the power distribution unit described in FIGS. 1-8B connected to one or more battery modules in parallel.

FIG. 10 illustrates a schematic diagram layout of the power distribution unit described in FIGS. 1-8B connected to one or more battery modules in parallel during an alternating current slow-charging process.

FIG. 11 illustrates a flow diagram illustrative of an implementations of a process for a fast-charging power-on and -off process.

FIG. 12 illustrates a flow diagram illustrative of an implementations of a process for a slow-charging power-on and -off process of the power distribution unit mentioned herein.

FIG. 13 illustrates a flow diagram illustrative of an implementations of a process to safely self-balance one or more battery modules within the modular battery system described in FIG. 1.

FIG. 14 illustrates a flow chart of a process for a high-voltage power on process of charging one or more battery modules.

FIG. 15 illustrates a flow chart of a process for a high-voltage power off process of one or more battery modules during a battery failure.

### DETAILED DESCRIPTION

Although certain configurations and examples are described below, this disclosure extends beyond the specifically disclosed configurations and/or uses and obvious modifications and equivalents thereof. Thus, it is intended that the scope of this disclosure should not be limited by any particular configurations described below. Furthermore, this disclosure describes many configurations in reference to power generation or reducing emissions of an internal combustion engine but any configurations and modifications or equivalents thereof should not be limited to the foregoing.

A battery module of an electric vehicle can include a Module Management Unit (MMU), a Battery Management System (BMS) receiving one or more parameters from the MMU, and at least two battery single-mode groups arranged in parallel and/or series. The battery single-mode group can include a plurality of battery modules connected in series, a connecting plate connecting two adjacent battery modules, a screw locking the battery modules together and a fastener fixing the screw.

For a Battery Management System (BMS), Module Management Unit (MMU) may refer to a component that is responsible for managing the individual battery cells within the battery modules. In a BMS, the MMU can be a microcontroller or a specialized chip that communicates with individual battery cells through a communication protocol such as CAN bus, SMBus, or SPI. The MMU monitors various parameters of each battery cell, including voltage, temperature, and state of charge (SoC), and uses this information to ensure that the battery cells are being charged and discharged properly. The MMU in a BMS may also perform various functions related to battery safety, such as monitoring for overvoltage and undervoltage conditions, overcurrent conditions, and overtemperature conditions. In addition, it may be responsible for balancing the charge levels of the individual cells in the battery pack to ensure that they are all at the same level.

A Power Distribution Unit (PDU) can be connected in parallel or in series with multiple battery modules, which can be combined in one or more configurations (for example, all battery module boxes and PDUs can be connected in parallel, or all battery module boxes and PDUs can be connected in series). The one or more configurations can meet the needs of energy vehicles and increase the capacity of batteries in parallel and/or in series. The battery modules can be standardized for modularity. The battery system can be produced in large quantities, reducing costs and increasing competitiveness. The PDU of the electric vehicle and the series or parallel connection of a plurality of battery modules have the advantages of: reducing the number of materials and molds; standardization and easy expansion, convenient disassembly; and fast conduction and heat conduction speed with small internal resistance.

In order to make the purpose, technical scheme, and beneficial technical effect of the disclosure clearer, the disclosure is further described in detail below in combination with the accompanying drawings and specific embodiments. It should be understood that the specific embodiments described in this specification are only for the purpose of explaining the disclosure and not for the purpose of defining the disclosure.

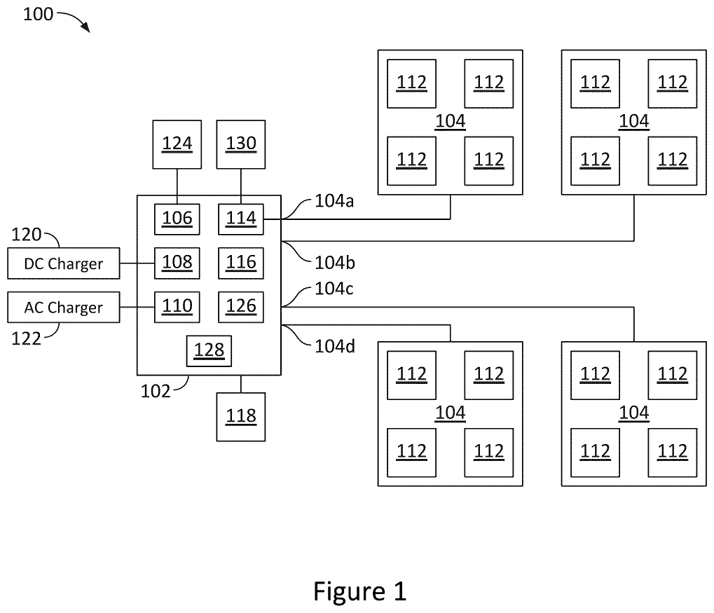

FIG. 1 illustrates an example block diagram of a modular battery system 100 that can be included within an electric vehicle. The modular battery system 100 can include a power distribution unit (PDU) 102 connected to one or more battery modules 104. The PDU 102 can also include a high voltage output 106 for providing high voltage power from the one or more battery modules 104 to an electric motor 124. The PDU 102 can include a direct current (DC) fast charging port 108 to be connected to a DC fast charging charger 120 to charge the one or more battery modules 104 and a DC fast-charging communication port 126 to communication with the DC fast charging charger 120. Additionally or alternatively, the PDU 102 can include an AC slow-charging port 110 to be connected to an AC slow-charging charger 122 to charge the one or more battery modules 104 and an AC slow charging communication port 128 to communication with the AC slow-charging charger 122. Ports 108 and 110 can be external energy sources (e.g., DC fast charging charger 120 and/or AC slow-charging charger 122). The PDU 102 can further include a vehicle communication interface 114. The vehicle commination interface 114 can connect to a motor controller 130. In some implementations, the DC fast charging charger 120 and AC slow-charging charger 122 are combined into one external energy source. In some implementations, the vehicle communication interface 114, DC fast charging communication port 126, and/or the AC slow charging communication port 128 can be combined into one port. The modular battery system 100 can include a wide range of voltages depending on the configuration needed. For example, the modular battery system 100 can have a voltage of 88V, of 350, and/or of 750V depending on the number of battery modules and whether the battery modules are in a parallel or series configuration. Further, quantity of voltage can dictate whether fast-charging or slow-charging is used. In the case of the 88V modular battery system, the 88V system can use slow charging for parallel charging. Turning to the 350V and 750V systems, the 350V and 750V systems can use fast charging due to the increased voltage quantity for parallel charging. The modular battery system 100 can further include a non-transitory memory to store specific computer-executable instructions and/or a hardware processor in communication with the non-transitory memory, where the hardware processor can execute the specific computer-executable instructions. In some implementations, the PDU 102 can include the non-transitory memory and/or the hardware processors.

The one or more battery modules 104 can include any number of battery cells 112 contained within the housing of the one or more battery modules 104. The battery cells 112 can be arranged in a number of configurations for a desired power output. The one or more battery modules 104 can be interchanged with other the one or more battery modules 104 when one or more of the one or more battery modules the one or more battery modules 104 fails and/or loses the capability to hold a sufficient charge.

The PDU 102 can further include or be in communication with an electronic vehicle communication controller (EVCC) 118. In an electric vehicle, the PDU 102 can manage the distribution of electrical power from the one or more battery modules 104 to various systems and components within the electric vehicle (e.g., high voltage output 106 and/or vehicle communication interface 114). The PDU 102 can deliver power safely and efficiently to the components that require it, such as the one or more battery modules 104, high voltage output 106, vehicle communication interface 114, battery charger, heating and cooling systems, and other auxiliary systems. The functions of the PDU 102 in an electric vehicle may vary depending on the design and configuration of the vehicle, but can include: regulating the flow of electrical power from the one or more battery modules 104 to the various systems and components in the vehicle, such that the power is delivered at the correct voltage and current levels; preventing damage to the electrical components in the event of overvoltage, overcurrent, and/or short circuits; and monitoring systems to track the state of the electrical components and diagnose any issues that may arise.

The PDU 102 can be configured for parallel arrangements, series arrangements, or have series of relays and software that can switch between parallel and series battery arrangements. The PDU 102 can be agnostic to the type of battery cells 112 housed in the battery modules 104. The PDU 102 can include a plurality of electrical interfaces 104a, 104b, 104c, 104d, 104n, for connecting to the one or more battery modules 104, the high voltage output 106, the DC fast charging port 108, and/or the AC slow-charging port 110. For example, if the PDU 102 has six ports or electrical interfaces, four of the ports can be connected to four battery modules, one port can be connected to the high voltage output 106, and one port can be connected DC fast charging port 108.

The high voltage output 106 can provide a high voltage energy source from the PDU 102 to the electric vehicle motor 124 for powering the electric motor 124. The high voltage output can depend on the type of electric vehicle and/or the system requirements. The PDU 102 can convert a high voltage DC power from the one or more battery modules 104 into a proper form for the electric motor 124. The PDU 102 can convert the DC power into AC power, adjust the voltage and/or current levels and/or mange the flow of the voltage and/or current to the electric motor 124.

The PDU 102 can further include a vehicle communication interface 114. The vehicle communication interface 114 communicates with the vehicle control unit to determine if the state of electric vehicle is safe (e.g., temperature levels, discharge limits, error messages, etc.). The vehicle communication interface 114 can be connected to a vehicle CAN BUS which is then connected to the different vehicle communications, such as the motor control unit 130, as well as a charging communication. The PDU 102 can also include an internal communication interface 116 that communicates with the one or more battery modules 104. The vehicle communication interface 114 and/or motor control unit 130 can also control the speed and/or torque of an electric motor 124 of the electric vehicle as well as the power steering. The vehicle communication interface 114 and/or motor control unit 130 can serve as an interface between the PDU 102 and the electric motor 124, controlling the amount of electrical power that flows from the one or more battery modules 104 to the electric motor 124. The motor control unit 130 can receive signals from an accelerator pedal and other sensors, such as the brake pedal and throttle position sensor, and uses this information to adjust the output of the electric motor 124 accordingly. The vehicle communication interface 114 and/or motor control unit 130 can manage the current, voltage, and frequency of the electricity sent to the electric motor 124 to ensure that it operates efficiently and safely.

The internal communication Interface 116 can communicate the health status of the one or more battery modules 104 to help determine the charging characteristics of the battery cells 112. Internal communication within a battery system can include the exchange of information, data, and control signals between the various components that make up the battery system. This communication can help ensure the safe and efficient operation of the battery, and to optimize its performance and longevity. The EVCC 118 can communicate between a charging source and the BMS 502 mentioned below. The EVCC 118 can receive charging signals from the charging source and authenticate said charging signal before the one or more battery modules 104 are charged.

The DC fast charging charger 120 can be in electrical communication with the PDU 102 to provide fast-charging capabilities (also known as Level 3 charging) to the one or more battery modules 104. The DC fast charging charger 120 can provide high voltage power to the one or more battery modules 104. The DC fast charging charger 120 can provide DC power directly from a power grid to the PDU 102 and/or one or more battery modules 104. The DC fast charging charger 120 can have a power output ranging from approximately 50 kilowatts (kW) to 350 kW. Thus, the DC fast charging charger 120 can charge the one or more battery modules 104 in approximately fifteen to approximately forty-five minutes. The DC fast charging charger 120 can operate between two hundred to one thousand volts.

The AC slow-charging charger 122 can be in electrical communication with the PDU 102 to provide slow-charging capabilities (also known as Level 1 and/or Level 2 charging) to the one or more battery modules 104. The AC slow-charging charger 122 can provide low voltage power to the one or more battery modules 104. The AC slow-charging charger 122 can convert AC power from the power grid for the PDU 102 to convert to DC power for the one or more battery modules 104. The AC slow-charging charger 122 can have a power output ranging from approximately 1 kW to 22 kW. Thus, an electric vehicle with two hundred miles of range can take thirty-five to fifty hours to charge, depending on the current and voltage. The AC slow-charging charger 122 can operate between approximately one hundred to approximately two hundred and forty volts.

The DC fast charging communication port 126 can exchange data between the PDU 102 and the DC fast charging charger 102 during a fast-charging session. The DC fast charging communication port 126 can communicate charging protocols, charging current, and/or charging voltage to the PDU 102.

The AC slow charging communication port 128 can exchange data between the PDU 102 and the AC slow charging charger 122 during a slow-charging session. The AC slow charging communication port 128 can communicate charging protocols, charging current, and/or charging voltage to the PDU 102.

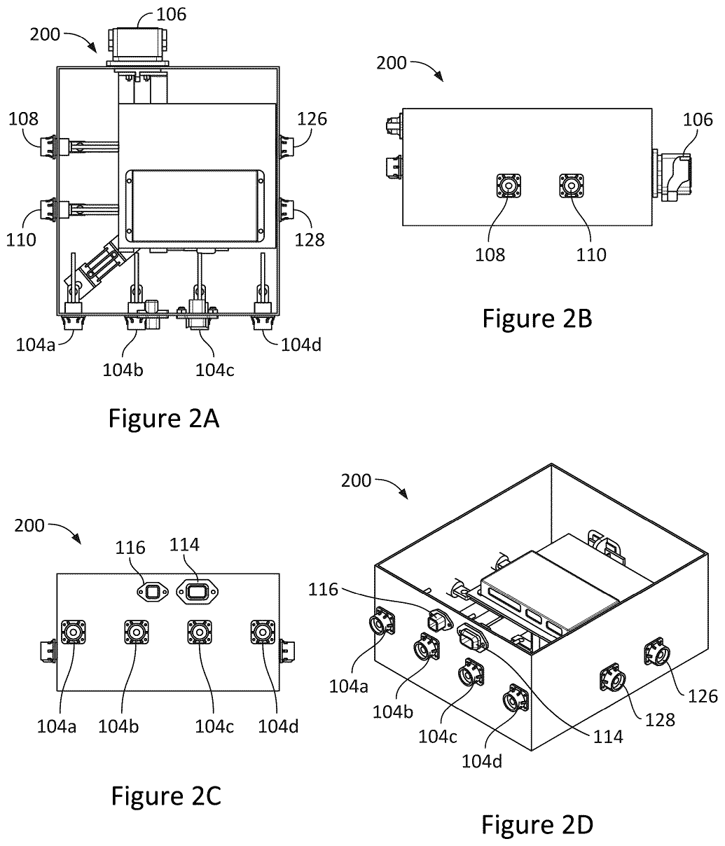

FIGS. 2A-2D illustrate perspective views of a two-way subsystem connection PDU 200. The PDU 200 can include any of the components of PDU 102 such as the plurality of electrical interfaces 104a, 104b, 104c, 104d, high voltage output 106, DC fast charging port 108, AC slow-charging port 110, internal communication interface 116, DC fast charging communication port 126, and/or AC slow charging communication port 128. The two-way subsystem connection PDU 200 in an electric vehicle can communicate with the various subsystems in the vehicle and provide power to them in a controlled and/or efficient manner. In an electric vehicle, there are various subsystems that require electrical power, such as the electric motor 124, the battery charger, the climate control system, and the entertainment and communication systems. The subsystems can have different power requirements and operate under different conditions, and therefore require different power management strategies. The two-way subsystem connection PDU 200 can communicate with the subsystems and receive information about their power requirements and operating conditions. Based on this information, the PDU 200 can adjust the power distribution to the subsystems to ensure that they receive the power they need while avoiding overloading the electrical system. For example, if the electric motor 124 requires more power during acceleration, the PDU 200 can adjust the power distribution to reduce the power going to other subsystems, such as the entertainment system or the climate control, to ensure that the electric motor 124 has sufficient power. Similarly, if the battery charger is operating at maximum capacity, the PDU 200 can reduce the power going to other subsystems to avoid overloading the electrical system. The one or more battery modules 104 can be connected to the PDU 200 by a two-way subsystem, which can be in parallel or series.

In some implementations, the PDU 200 can be connected in parallel with the one or more battery modules 104 such that the total voltage of the one or more battery modules 104 remains unchanged, but the capacity of the one or more battery modules 104 is increased. If the one or more battery modules 104 are in series, the capacity of the battery module 104 can remain unchanged (ah), but the total voltage can increase (V). In some implementations, the one or more battery modules 104 can be selected in parallel or in series. In some implementations, up to 16 battery modules can be connected to the PDU 200.

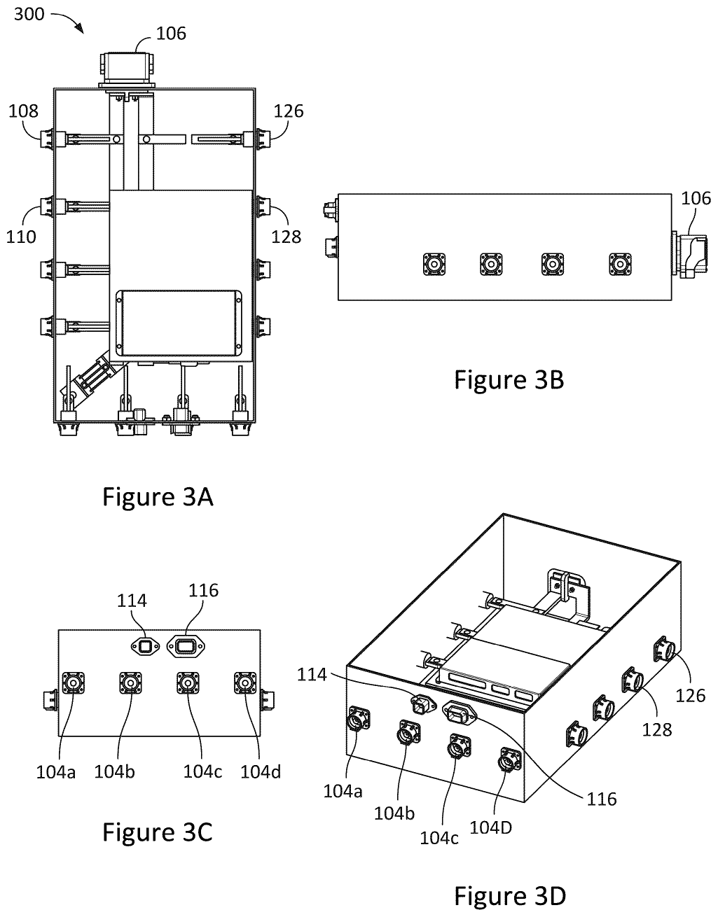

In one implementation, as shown in FIGS. 3A-3D, the battery module 104 can be connected to a four-way subsystem PDU 300 in combination diagram with four subsystems, which can be in parallel or in series. The PDU 300 can include any of the components of PDU 102 such as the plurality of electrical interfaces 104a, 104b, 104c, 104d, high voltage output 106, DC fast charging port 108, AC slow-charging port 110, internal communication interface 116, DC fast charging communication port 126, and/or AC slow charging communication port 128. The four-way subsystem PDU 300 can distribute power to four different subsystems in the vehicle. This type of PDU is designed to manage the power distribution for a larger number of subsystems, compared to the two-way subsystem PDU 200 which can distribute power to two subsystems. The four-way subsystem PDU 300 can distribute power to these subsystems in a controlled and efficient manner, based on their power requirements and operating conditions. The four-way subsystem PDU 300 can also overcurrent protection, short-circuit protection, and overvoltage protection to ensure safe and reliable operation of the electrical system.

Additionally or alternatively, the four-way subsystem PDU 300 may also include communication interfaces to enable two-way communication with the subsystems and a Battery Management System (BMS), enabling the four-way subsystem PDU 300 to receive information about the power requirements and operating conditions of the subsystems and adjust the power distribution accordingly. If the PDU 300 is connected in parallel with multiple battery modules, the total voltage of the battery module remains unchanged (V), but the capacity of the battery module is increased (ah). If it is connected in series, the capacity of the one or more battery modules 104 can remain unchanged, but the total voltage will increase. In some embodiments, the one or more battery modules 104 can be selected in parallel or in series. In some implementations, up to 16 battery modules can be connected to the PDU 300.

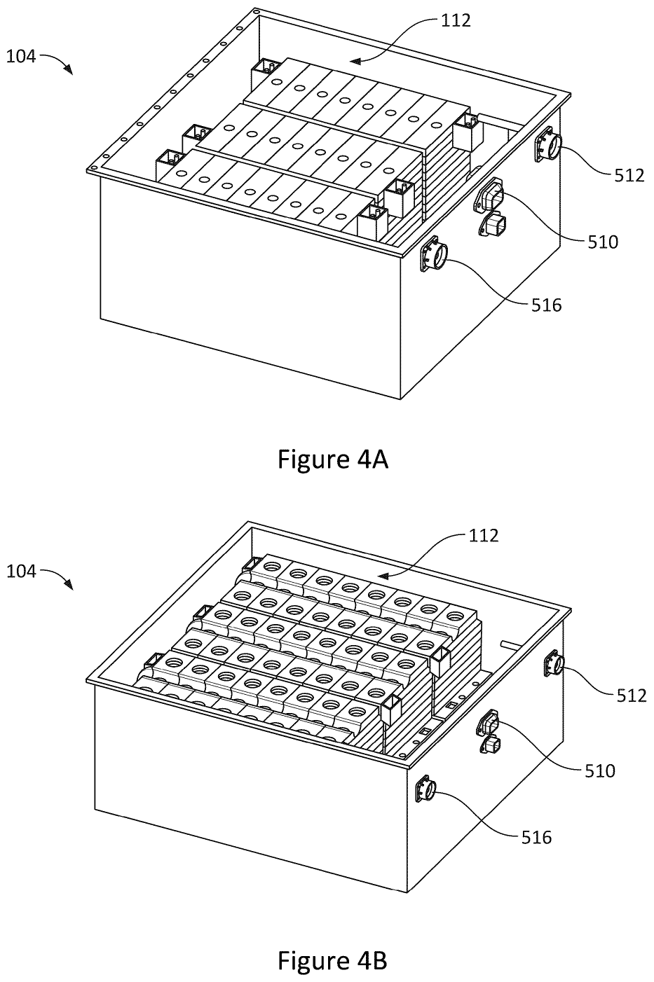

As shown in FIGS. 4A and 4B, the battery module 104 can use two-way or four-way parallel or series, and can use cells with different capacities, and can also be applicable to the schematic diagram. For example, 105ah and 160 ah batteries can be used in various formats. The difference is the size of the battery module box. At the same time, the one or more battery modules 104 can be illustrated by two-way, four-way parallel or series connection. As described herein, the one or more battery modules can include a positive terminal 510, a negative terminal 512, and/or an internal communication interface 516 for connecting with the components of system 100.

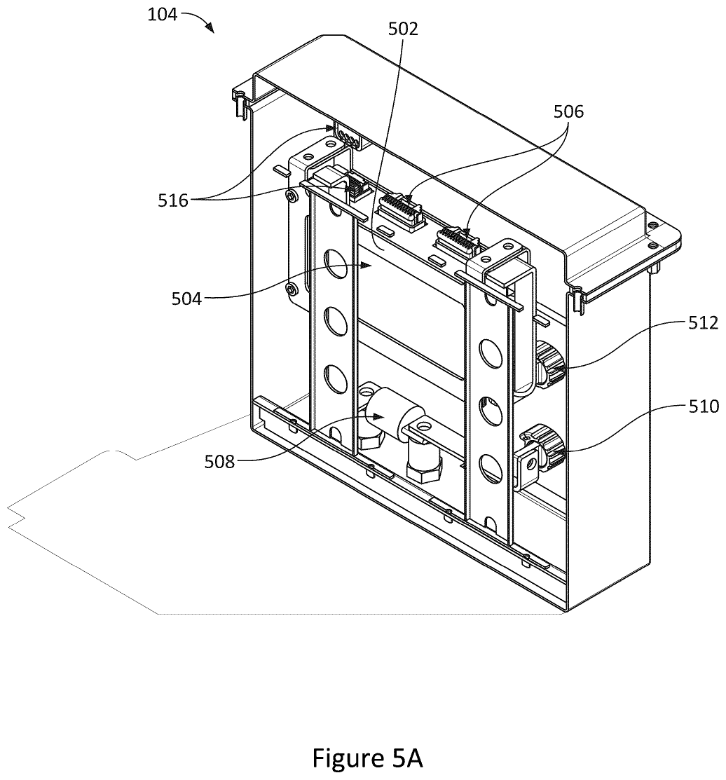

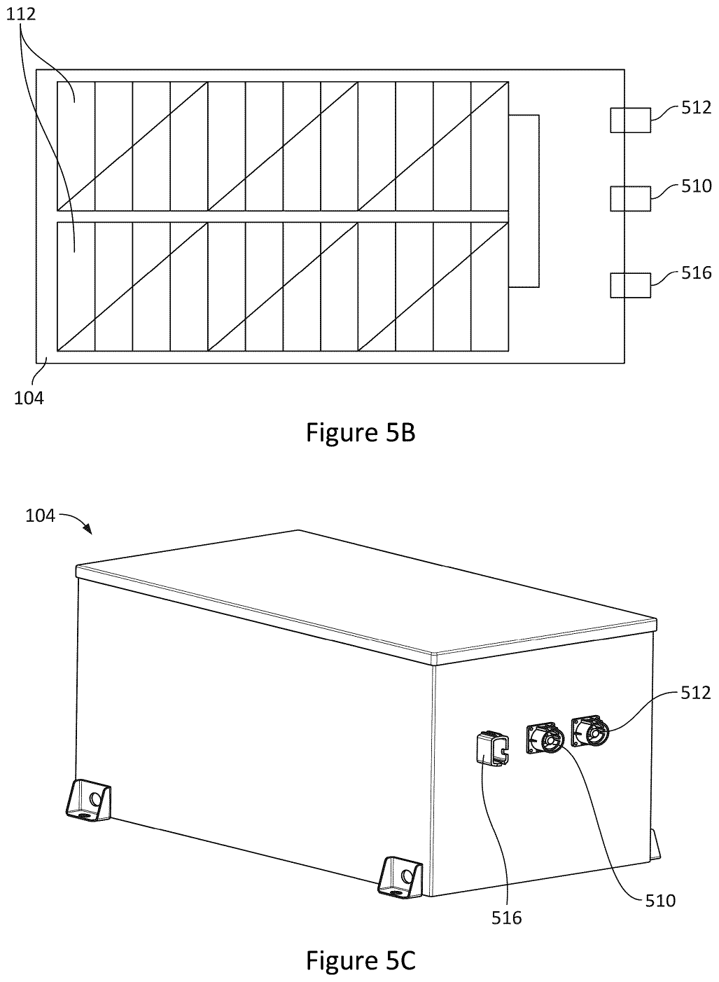

FIGS. 5A-5C illustrate schematic views of an exemplary battery module 104. The battery module 104 can include a battery management system (BMS) 502, a module management unit (MMU) 504, one or more battery management ports 506, fuses 508, a positive terminal 510, a negative terminal 512, and/or an internal communication interface 516. Functions, protocols, and/or processes being implemented by the BMS 502 as discussed herein can be performed by the MMU 504. In some implementations, the BMS 502 and/or the MMU 504 can include non-transitory memory to store specific computer-executable instructions and/or a hardware processor in communication with the non-transitory memory, where the hardware processor can execute the specific computer-executable instructions.

The BMS 502 can monitor the battery cells 112 housed in the battery module 104 and check for any potential battery failures. The BMS 502 can monitor the voltage, temperature, current, SoC, and/or battery health of the battery module 104. If the BMS 502 detects any abnormal conditions and/or faults, such as a low voltage, high temperature, high current, low SOC, or degraded battery health, the BMS 502 can alert the PDU 102, 200, 300 and take appropriate action to protect the battery and the vehicle. In some implementation, the BMS 502 can disconnect the battery module 104 from the PDU 102, 200, 300 to prevent further damage and/or unsafe operation.

The one or more battery management ports 506 can be connectors in communication with the BMS 502 for the monitoring and management of the battery modules 104. The MMU 504 can communicate with the BMS 502 and monitor the battery cells 112 housed in the battery module 104. The MMU 504 can monitor and/or control the charging and/or discharging of the battery module 104 and the battery cells 112, which can be connected in series or parallel. The MMU 504 can also balance the battery cells 112 so that the voltage and SOC of each of the battery cells 112 are equalized, which can improve the overall performance and/or lifespan of the battery module 104. The one or more battery management ports 506 can provide access to information about the battery modules 104, such as the SOC, voltage, temperature, and/or other parameters. The one or more battery management ports 506 can also enable communication with other devices, such as chargers, inverters, and controllers, to assist in performance and longevity of the battery modules 104. The MMU 504 can include a non-transitory memory to store specific computer-executable instructions and/or a hardware processor in communication with the non-transitory memory, where the hardware processor can execute the specific computer-executable instructions.

The fuses 508 can protect the electrical circuits of battery modules 104 from overloading and short circuits. The fuses 508 can include a metal wire or filament that melts and breaks the circuit when a current exceeds a safe level.

The battery module 104 can include a positive terminal 510 and a negative terminal 512 can be electrical contacts used to connect a load and/or charge to the battery module 104. The internal communication interface 516 can communicate with the MMU 504 and battery management system to transfer the health status of the battery module 104 and to determine the charging characteristics of the battery cells 112.

The explosion-proof breathable valve 518 can be a safety device for protecting the one or more battery modules 104 from potential explosions and/or other hazards that may arise due to a buildup of pressure and/or other factors. The explosion-proof breathable valve 518 can open if the pressure within the one or more battery modules 104 reaches a dangerous level, allowing the release of gas and/or other materials to prevent an explosion. The explosion-proof breathable valve 518 can include a metal and/or plastic housing with a porous membrane and/or vent to flow gas and/or other materials out of the one or more battery modules 104 while preventing the entry of dust, moisture, and/or other contaminants. The explosion-proof breathable valve 518 can be designed to operate at predetermined pressure and/or temperature threshold. explosion-proof breathable valve 518 can be replaceable if it becomes damaged and/or worn over time.

The one or more battery modules 104 can be classified in terms of a discharge rate (i.e., amount of current that a battery can provide in a given time). The classification of the one or more battery modules 104 can be calculated by first determining the amp per hour of the cell and then the amps discharged over a time interval. For example, a 100 amp per hour cell in which 100 A are discharged in one hour has a non-dimensional value of 1c. In another example, a 50 amp per hour cell in which 50 amps are discharged in half an hour has a non-dimensional value of 2c. The one or more battery modules 104 can have a rating of 3c for discharge, which can correspond to 315 amps, and rated 2c for charging, which can correspond to 210 amps. Table 1 illustrates a matrix table of continuous maximum continuous discharge current (A) of the one or more battery modules 104 at corresponding temperatures and state of charge.

TABLE 1
Continuous Maximum Continuous Discharge Current (A)

| Temperature | | | | | | | | |
|---|---|---|---|---|---|---|---|---|
| State of Charge | Temperature | | | | | | | |
| (SOC)/% | 55° C. | 50° C. | 45° C. | 25° C. | 10° C. | 0° C. | −10° C. | −20° C. |
| 100 | 210 A | 210 A | 315 A | 315 A | 315 A | 210 A | 105 A | 105 A |
| 90 | 210 A | 210 A | 315 A | 315 A | 315 A | 210 A | 105 A | 105 A |
| 80 | 210 A | 210 A | 315 A | 315 A | 315 A | 210 A | 105 A | 105 A |
| 70 | 210 A | 210 A | 315 A | 315 A | 315 A | 105 A | 105 A | 63 A |
| 60 | 210 A | 210 A | 315 A | 315 A | 210 A | 105 A | 63 A | 63 A |
| 50 | 210 A | 210 A | 315 A | 315 A | 210 A | 105 A | 63 A | 42 A |
| 40 | 210 A | 210 A | 315 A | 315 A | 105 A | 63 A | 63 A | 42 A |
| 30 | 105 A | 105 A | 210 A | 210 A | 105 A | 63 A | 42 A | 42 A |
| 20 | 105 A | 105 A | 210 A | 210 A | 105 A | 63 A | 42 A | 0 |
| 10 | 63 A | 63 A | 105 A | 105 A | 63 A | 42 A | 0 | 0 |
| 0 | 0 | 0 | 0 | 0 | 0 | 0 | 0 | 0 |

Table 2 illustrates a table of exemplary maximum discharge current for 30 second at various states of charge and temperatures of the one or more battery modules 104.

TABLE 2
Maximum Discharge Current (30 seconds)

| | SOC (%) Temperature | | | | | | | | | | |
|---|---|---|---|---|---|---|---|---|---|---|---|
| Temperature | 100 | 90 | 80 | 70 | 60 | 50 | 40 | 30 | 20 | 10 | 0 |
| 55° C. | 210 A | 210 A | 210 A | 210 A | 210 A | 210 A | 210 A | 210 A | 157.5 A | 105 A | 0 |
| 45° C. | 315 A | 315 A | 315 A | 315 A | 315 A | 315 A | 315 A | 315 A | 210 A | 157.5 A | 0 |
| 25° C. | 315 A | 315 A | 315 A | 315 A | 315 A | 315 A | 315 A | 315 A | 210 A | 157.5 A | 0 |
| 10° C. | 315 A | 315 A | 315 A | 315 A | 315 A | 315 A | 210 A | 210 A | 105 A | 105 A | 0 |
| 0° C. | 315 A | 315 A | 315 A | 210 A | 210 A | 210 A | 105 A | 105 A | 105 A | 42 A | 0 |
| −10° C. | 210 A | 210 A | 210 A | 210 A | 105 A | 105 A | 42 A | 42 A | 42 A | 0 | 0 |
| −20° C. | 126 A | 126 A | 126 A | 126 A | 63 A | 63 A | 63 A | 21 A | 21 A | 0 | 0 |

Table 3 illustrates a table of exemplary maximum charge current for 30 second at various states of charge and temperatures of the one or more battery modules 104.

TABLE 3
Maximum Charge Current (30 seconds)

| | SOC (%) Temperature | | | | | | | | | | |
|---|---|---|---|---|---|---|---|---|---|---|---|
| Temperature | 100 | 90 | 80 | 70 | 60 | 50 | 40 | 30 | 20 | 10 | 0 |
| 55° C. | 0 | 21 A | 21 A | 21 A | 21 A | 42 A | 42 A | 42 A | 42 A | 42 A | 42 A |
| 50° C. | 0 | 42 A | 42 A | 42 A | 42 A | 105 A | 105 A | 105 A | 105 A | 105 A | 105 A |
| 45° C. | 0 | 105 A | 105 A | 105 A | 105 A | 210 A | 210 A | 210 A | 210 A | 210 A | 210 A |
| 25° C. | 0 | 105 A | 210 A | 210 A | 210 A | 210 A | 210 A | 210 A | 210 A | 210 A | 210 A |
| 10° C. | 0 | 21 A | 42 A | 105 A | 210 A | 210 A | 210 A | 210 A | 210 A | 210 A | 210 A |
| 0° C. | 0 | 0 | 42 A | 42 A | 42 A | 42 A | 105 A | 105 A | 105 A | 105 A | 105 A |

Table 4 illustrates a table of exemplary standard operating procedure power meter values of the one or more battery modules 104 at various SOCs and temperatures.

TABLE 4
Operating Procedure Power Meter
Example Lithium Iron Phosphate Cell 3.2 V 105 Ah (LFP105)

| | Open Circuit Voltage (OCV) | | | | | | | |
|---|---|---|---|---|---|---|---|---|
| | −5° C. | | 10° C. | | 25° C. | | 45° C. | |
| State of | | unload | | unload | | unload | | unload |
| Charging | | discharge | | discharge | | discharge | | discharge |
| (SOC) | charge | electricity | charge | electricity | charge | electricity | charge | electricity |
| 0 | 3.0803 | / | 3.0670 | 2.9141 | 2.9470 | 3.0071 | 3.0096 | 2.7957 |
| 5 | 3.2276 | / | 3.2217 | 3.2021 | 3.2136 | 3.2068 | 3.2164 | 3.1758 |
| 10 | 3.2418 | 3.2167 | 3.2356 | 3.2121 | 3.2251 | 3.2127 | 3.2279 | 3.2065 |
| 15 | 3.2744 | 3.2431 | 3.2691 | 3.2387 | 3.2561 | 3.2412 | 3.2604 | 3.2288 |
| 20 | 3.2964 | 3.2648 | 3.2921 | 3.2626 | 3.2821 | 3.2626 | 3.2859 | 3.2527 |
| 25 | 3.3041 | 3.2772 | 3.3035 | 3.2812 | 3.2989 | 3.2806 | 3.2989 | 3.2688 |
| 30 | 3.3045 | 3.2824 | 3.3041 | 3.2886 | 3.3032 | 3.2930 | 3.3066 | 3.2899 |
| 35 | 3.3048 | 3.2837 | 3.3048 | 3.2896 | 3.3041 | 3.2942 | 3.3076 | 3.2952 |
| 40 | 3.3054 | 3.2843 | 3.3054 | 3.2905 | 3.3051 | 3.2948 | 3.3085 | 3.2955 |
| 45 | 3.3066 | 3.2852 | 3.3063 | 3.2914 | 3.3063 | 3.2958 | 3.3097 | 3.2964 |
| 50 | 3.3091 | 3.2877 | 3.3082 | 3.2927 | 3.3076 | 3.2973 | 3.3116 | 3.2973 |
| 55 | 3.3243 | 3.2939 | 3.3134 | 3.2986 | 3.3110 | 3.3029 | 3.3153 | 3.3007 |
| 60 | 3.3404 | 3.3063 | 3.3417 | 3.3231 | 3.3395 | 3.3320 | 3.3404 | 3.3302 |
| 65 | 3.3426 | 3.3237 | 3.3432 | 3.3320 | 3.3410 | 3.3342 | 3.3401 | 3.3317 |
| 70 | 3.3423 | 3.3283 | 3.3426 | 3.3327 | 3.3410 | 3.3345 | 3.3401 | 3.3317 |
| 75 | 3.3410 | 3.3296 | 3.3423 | 3.3330 | 3.3410 | 3.3351 | 3.3401 | 3.3320 |
| 80 | 3.3398 | 3.3299 | 3.3410 | 3.3333 | 3.3407 | 3.3355 | 3.3401 | 3.3324 |
| 85 | 3.3382 | 3.3305 | 3.3401 | 3.3339 | 3.3407 | 3.3367 | 3.3401 | 3.3333 |
| 90 | 3.3373 | 3.3305 | 3.3389 | 3.3342 | 3.3404 | 3.3373 | 3.3401 | 3.3339 |
| 95 | / | 3.3305 | / | 3.3355 | 3.3395 | 3.3389 | 3.3401 | 3.3351 |
| 100 | / | 3.4089 | / | 3.3575 | / | 3.3599 | / | 3.4136 |

A control strategy can be implemented for on board charging of the one or more battery modules 104. For example, charging control parameters of the one more battery modules 104 can include a maximum allowable monomer voltage (i.e., a voltage of one of the one or more battery modules 104 either in series and/or in parallel) between 1 volt to 6 volts, between 1.25 volts to 5.75 volts, between 1.5 volts to 5.5 volts, between 1.75 volts to 5.25 volts, between 2 volts to 5 volts, between 2.25 bolts to 4.75 volts, between 2.5 volts to 4.5 volts, between 2.75 volts to 4.25 bolts, between 3 volts to 4 volts, or between 3.25 volts to 3.75 volts. Charging control parameters of the one or more battery modules 104 can include a maximum allowable total voltage between 75 volts to 105 volts, between 80 volts to 100 volts, between 85 volts to 95 volts, or between 87.5 volts to 92.5 volts. Charging control parameters of the one or more battery modules 104 can include a minimum monomer voltage between 1 volt to 3 volts, between 1.25 volts to 2.75 volts, between 1.5 volts to 2.5 volts, between 1.75 volts to 2.25 volts, between 1.8 volts to 2.2 volts, or between 1.9 volts to 2.1 volts. Charging control parameters of the one or more battery modules 104 can include a maximum allowable charging current between 20 A to 60 A, between 25 A to 55 A, between 30 A to 50 A, between 35 A to 45 A, or between 37.5 A to 42.5 A. Charging control parameters of the one or more battery modules 104 can include a minimum allowable charging current between 1 A to 20 A, between 5 A to 15 A, between 7.5 A to 12.5 A, between 8 A to 12 A, or between 9 A to 11 A. Charging control parameters of the one or more battery modules 104 can include a maximum allowable charging temperature between 35° C. to 75° C., between 40° C. to 70° C., between 45° C. to 65° C., between 50° C. to 60° C., or between 52.5° C. to 57.5° C. Charging control parameters of the one or more battery modules 104 can include a minimum allowable charging temperature between −15° C. to 15° C., between −10° C. to 10° C., between −5° C. to 5° C., between −2.5° C. to 2.5° C., or between −1° C. to 1° C.

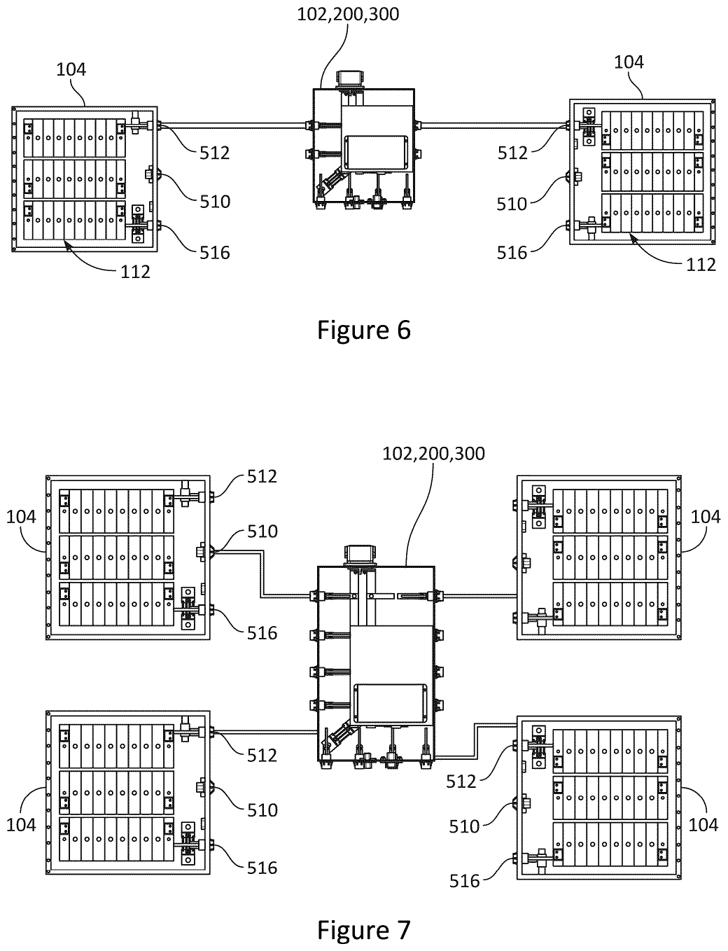

As shown in FIGS. 6 and 7, the battery module 104 can be connected with the PDU 102, 200, 300 in parallel or in series with two or four channels. For example, one to sixteen of the one or more battery modules 104 can be connected in parallel or in series, and can increase or reduce the series or parallel of battery modules. In some embodiments, each time the series or parallel of battery modules is adjusted, it should be confirmed that the voltage and capacity between each battery module is consistent, and the firmware of PDU 102 should be changed, and the control of PDU 102 should be consistent with the actual battery module. In some embodiments, the battery module of the electric vehicle of the disclosure uses two-way and four-way battery module subsystems to connect PDU in parallel or in series. This is illustrated by four battery modules. Any of the PDUs 102, 200, 300 can connect one to sixteen the one or more battery modules 104 in parallel or in series and can connect 16 battery modules in some embodiments. When the batteries are connected in series, the battery modules can be plugged into one of the four battery ports of the PDUs 102, 200, 300. As mentioned herein, the one or more battery modules 104 can include a positive terminal 510, a negative terminal 512, and/or an internal communication interface 516 for connecting with the PDUs 102, 200, 300 or any of the other one or more battery modules 104.

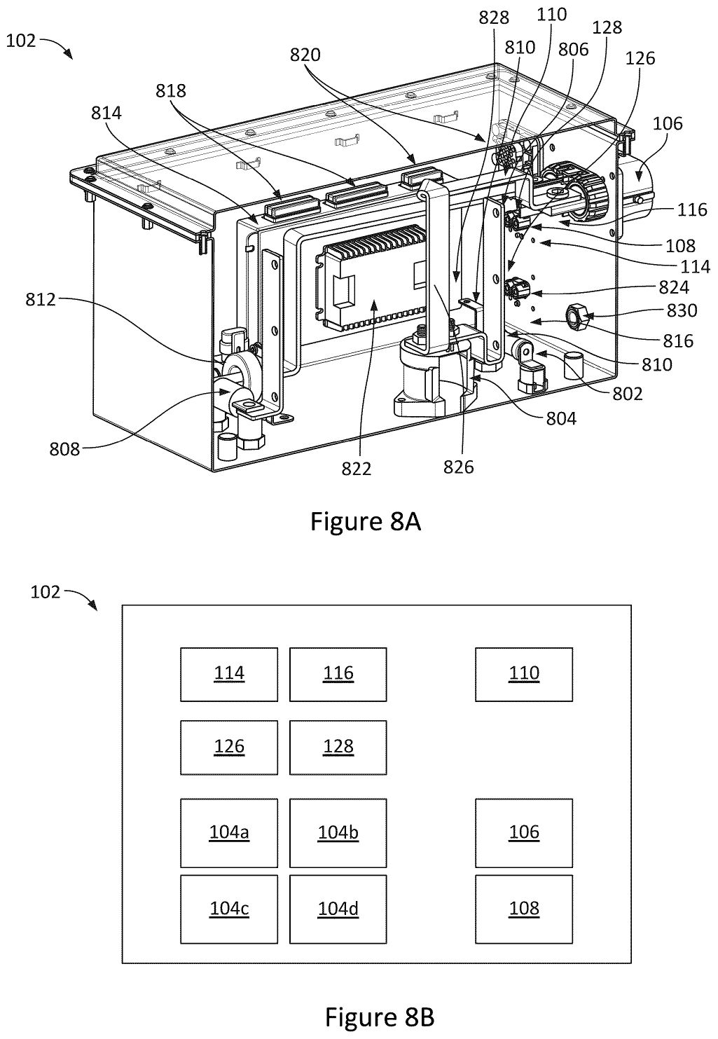

FIGS. 8A and 8B illustrates sectional views of any of the PDUs described herein, for example, PDU 102. The PDU 102 can include, in addition to the components described in FIG. 1, pre-charge resistors 802, pre-charge relays 804, charging relays 805, slow-charging relays 806, charging fuses 808, slow-charging fuses 810, hall effect sensors 812, battery management units (BMU) 814, master service disconnects 816, battery management system ports 818, communication ports 820, DC-DC converters 822, DC-DC ports 824, bus bars 826, and/or an explosion-proof breathable valve 830.

The pre-charge resistors 802 can protect the PDU 102 when initially receiving a charge from a fast and/or slow-charger. The pre-charge resistors 802 can be an electronic component used in pre-charge circuits, for example, high voltage system greater than fifty volts, that employ capacitors 828 to store electrical energy. When a circuit is turned on, a large initial current surge can occur as the capacitors 828 charge up to its full voltage which may results in damage to the modular battery system 100. The pre-charge resistors 802 can limit the initial current surge by allowing the capacitor 828 to charge up more slowly, which can protect the circuit and reduce interference. The pre-charge resistors 802 can be placed in series with the capacitor 828 and the power source (e.g., the one or more battery modules 104 or charger). As current flows through the pre-charge resistors 802, it gradually charges up the capacitor 828 until it reaches its full voltage. Once the capacitor 828 is fully charged, the pre-charge resistors 802 is bypassed and the circuit operates normally. The value of the pre-charge resistors 802 can be chosen based on at least the capacitance of the capacitor 828 and the maximum current rating of the circuit components. A pre-charge resistor with too high a value can cause the capacitors 828 to charge up too slowly, which can delay the operation of the circuit. Conversely, a pre-charge resistors 802 with too low a value can still allow a large initial current surge to occur.

The pre-charge relays 804 can be an electrical switch that opens and/or closes a circuit. The pre-charge relays 804, along with the pre-charge resistors 802, can be used to gradually charge one or more high-voltage capacitors 828 in the vehicle's electrical system before full power is supplied to the one or more battery modules 104. The pre-charge relays 804 can protect the electronic components and the one or more battery modules 104 from damage that could result from a sudden surge of current when the system is energized and/or charged. When an electric vehicle is energized and/or charged, such as when the driver activates the power switch, and/or a fast-charging charger is connected to connection port, the pre-charge relays 804 closes, allowing a small amount of current to flow to the capacitors 828. The current slowly charges the capacitors 828, which act as energy storage devices for the electrical system. Once the capacitors 828 are fully charged, the pre-charge relays 804 opens, and the charging relays 805 in the vehicle's electrical system closes, allowing full power to flow to the motor 124 and other subsystems. The pre-charge relays 804 can also serves as a safety device in the event of a fault or malfunction in the electrical system. If a fault is detected during the pre-charge process, the pre-charge relays 804 will open and prevent full power from being applied to the system, preventing damage to the system.

The charging relays 805 and slow-charging relays 806 can be a type of electrical switch used in control systems to switch circuits on or off. In a fast-charging system, a high amount of electrical power needs to be delivered to the battery of the vehicle in a short period of time. To do this, a high voltage DC power source is used to charge the battery. The pre-charge relays 804 acts as a switch that controls the flow of power between the power source and the battery (e.g., the charger and PDU 102). The pre-charge relays 804 can be designed to handle the high voltage and current levels required for fast charging and can turn on and off quickly to regulate the charging process. The charging relay 804 can be controlled by a charging station or the vehicle's onboard charging system and can be programmed to deliver the appropriate amount of power for the specific battery being charged. By controlling the charging process in this way, the pre-charge relays 804 helps to ensure that each of the one or more battery modules 104 can be charged quickly and safely.

The slow-charging relays 806 can be a type of electrical relay designed to protect the battery in a vehicle or other electrical system from damage due to overcharging. The slow-charging relays 806 can be used in systems that rely on slow-charging methods, such as when charging electric vehicles. The slow-charging relays 806 open or close a circuit based on the SOC of the one or more battery modules 104. When the one or more battery modules 104 are fully charged, the slow-charging relays 806 can open the circuit, preventing any further charging from occurring and the one or more battery modules 104 from overheating or being damaged by overcharging. The slow-charging relays 806 can also be used to help extend the life of a the one or more battery modules 104 by preventing the one or more battery modules 104 from being discharged too deeply. By monitoring the voltage of the one or more battery modules 104 and shutting off the circuit before the battery is fully discharged, the slow-charging relays 806 can help prevent damage to the battery and extend its useful life. The charging relays 805 and slow-charging relays 806 can include positive and/or negative relays.

Additionally or alternative, the charging relays 805 and slow-charging relays 806 can include high side relays and/or low side relays. A positive relay is a type of relay that operates when the input signal exceeds a specific threshold value, which can be set by an adjustable voltage and/or current level. When the input signal reaches this threshold, the relay switches from its normally open (NO) position to its normally closed (NC) position, or vice versa. Positive relays are also known as “make” relays, as they make a connection when the threshold is exceeded. On the other hand, a negative relay operates when the input signal falls below a specific threshold value. When the input signal falls below this threshold, the relay switches from its normally closed (NC) position to its normally open (NO) position, or vice versa. Negative relays are also known as “break” relays, as they break a connection when the threshold is exceeded. High side and low side relays can be two types of electrical relays used in a variety of applications. A high side relay can be a relay that is connected between the power source and the load. High side relays can be used to interrupt the power supply to a load, such as in automotive systems, where high side relays can control high-power loads such as headlights, motors, and heaters. A low side relay can be connected on the low side of the load between the load and ground. Low side relays can be used to control small loads such as LED lights or solenoids. Using a high side or low side relay depends on the specific application requirements, such as the voltage and current levels, the type of load, and the control circuitry.

The charging fuses 808 and slow-charging fuses 810 protect the electrical circuits of modular battery system 100 from overloading and short circuits. The charging fuses 808 and slow-charging fuses 810 can include a metal wire or filament that melts and breaks the circuit when a current exceeds a safe level. The Hall effect sensors 812 can sense the presence and strength of a magnetic field. The Hall effect sensors 812 can work based at least on the principle of the Hall effect, which is the creation of a voltage difference (Hall voltage) across a conductor when a magnetic field is applied perpendicular to the direction of current flow in the conductor. The Hall effect sensors 812 can include of a thin strip of semiconductor material with a small hole in it. When a magnetic field is applied perpendicular to the plane of the semiconductor strip, the Hall voltage is generated, which is proportional to the strength of the magnetic field. This voltage can be measured using the contacts on the semiconductor strip.

The BMU 814 can be housed within PDU 102, where the PDU 102 manages the charging and discharging of the one or more battery modules 104. Functions, protocols, and/or processes being implemented by the PDU 102 as discussed herein can be performed by the BMU 814. The BMU 814 receives information from the one or more battery modules 104, such as the voltage and/or temperature. The BMU 814 can include relay controls (e.g., charging relays 804, 805, and 806) to manage the charging process of the one or more battery modules 104. The BMU 814 can also monitor the received voltage and temperature of the battery cells 112 in each of the one or more battery modules 104 to determine whether the battery cells 112 are balanced in terms of charge and discharge. Monitoring the battery 112 can prevent overcharging or undercharging of the battery cells 112, which can lead to reduced battery life or even safety hazards. The BMU 814 can also estimate the SOC of the battery modules 104 based at least on the voltage, current, and/or temperature measurements. The BMU 814 can include non-transitory memory to store specific computer-executable instructions and/or a hardware processor in communication with the non-transitory memory, where the hardware processor can execute the specific computer-executable instructions.

The BMU 814 can also detect a change in the arrangement of the one or more battery modules 104 such as when the change includes adding and/or subtracting a battery module 104 from the one or more battery modules 104. The BMU 814 can also calculate a new SOC of the one or more battery modules 104 following a change in the arrangement of the one or more battery modules 104. The BMU 814 can detect the change in the arrangement during a wake-up state upon powering on the PDU 102. The change can include switching the one or more battery modules 104 from a parallel connection to a series connection or from a series connection to a parallel connection.

The master service disconnects 816 (also referred to as a “main battery disconnect switch” or the “kill switch”) can be a switch used to disconnect the battery modules 104 from the PDU 102, cutting off all power to the electric vehicle. The battery management system ports 818 can be connectors in communication with the BMS 502 for the monitoring and management of the battery modules 104 as well as the vehicle communication interface 114.

The battery management system ports 818 can provide access to information about the battery modules 104, such as the SOC, voltage, temperature, and/or other parameters. The battery management system ports 818 can also enable communication with other devices, such as chargers, inverters, and controllers, to assist in performance and longevity of the battery modules 104.

The communication ports 820 can be interfaces that enable the PDU 102 to communicate with other components in the vehicle's electrical system as well as any charging sources to regulate the AC input. The communication ports 820 can allow the PDU 102 to send and/or receive information about the status and operation of the electrical system, as well as to receive commands from other components. For example, the communication ports 820 can be a controller area network (CAN) ports to enable the communication ports 820 to communicate with the BMS 502, vehicle communication interface 114, and/or other components in the vehicle.

The DC-DC converter 822 can convert a DC voltage from one level to another level. The DC-DC converter 822 can take as an input DC voltage and produces a regulated output DC voltage, either higher or lower than the input voltage level. The DC-DC converter 822 can be classified into several different types, such as buck, boost, buck-boost, and/or isolated converters, depending on their configuration and mode of operation. The DC-DC converter 822 can be used to regulate the output voltage and/or minimize the effects of fluctuations in the input voltage, providing stable and reliable power to sensitive electronic devices. The DC-DC ports 824 can be a connector for supplying DC current to the PDU 102. The bus bar 826 can be a metallic strip and/or bar for high current distribution within the PDU 102. The material composition and cross-sectional size of the bus bar 826 can determine the maximum current that can the bus bar 826 can carry. The bus bar 826 can be bent and/or manipulated to fit around other components within the PDU 102.

The explosion-proof breathable valve 830 can be a safety device for protecting the PDU 102 from potential explosions and/or other hazards that may arise due to a buildup of pressure and/or other factors. The explosion-proof breathable valve 518 can open if the pressure within the PDU 102 reaches a dangerous level, allowing the release of gas and/or other materials to prevent an explosion. The explosion-proof breathable valve 518 can include a metal and/or plastic housing with a porous membrane and/or vent to flow gas and/or other materials out of the PDU 102 while preventing the entry of dust, moisture, and/or other contaminants. The explosion-proof breathable valve 830 can be designed to operate at predetermined pressure and/or temperature threshold. explosion-proof breathable valve 830 can be replaceable if it becomes damaged and/or worn over time.

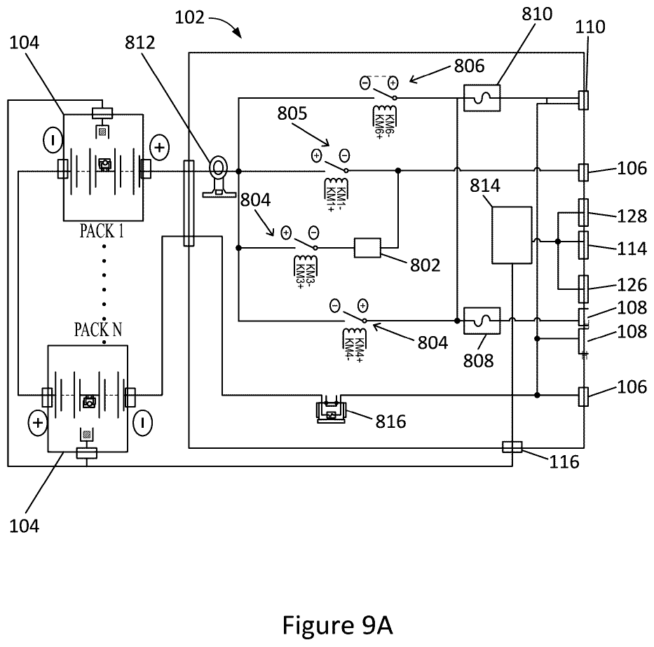

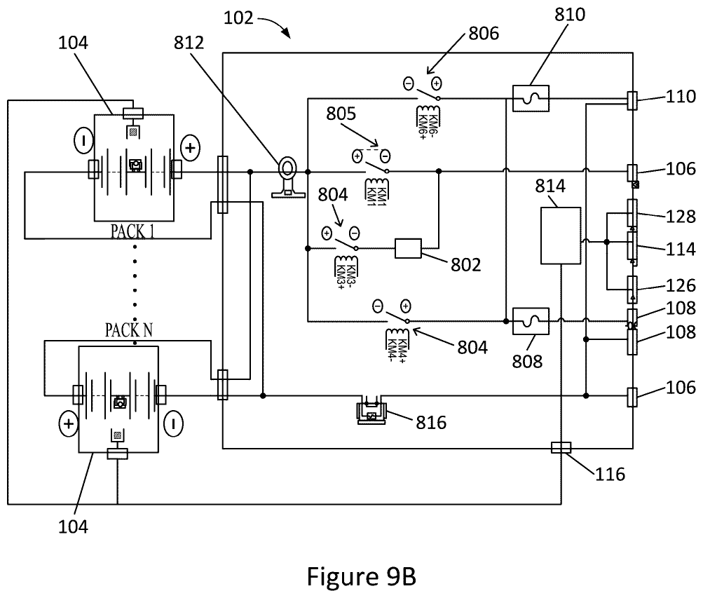

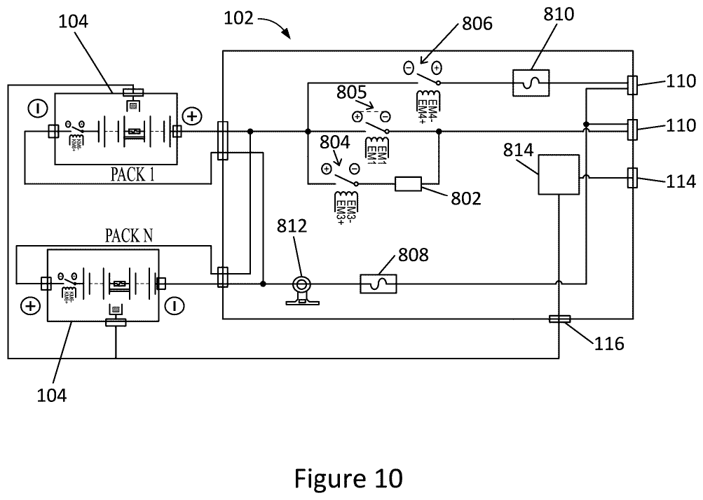

FIG. 9A illustrates a schematic diagram layout of the PDU 102 described in FIGS. 1-8B. The PDU 102 can be illustrated as being electrically connected to one or more battery modules 104 in series. FIG. 9B illustrates another schematic diagram layout of the PDU 102 described in FIGS. 1-8B. The PDU 102 can be illustrated as being electrically connected to one or more battery modules 104 in parallel. FIG. 10 illustrates a schematic diagram layout of the power distribution unit described in FIGS. 1-8B connected to one or more battery modules in parallel during an AC slow-charging process.

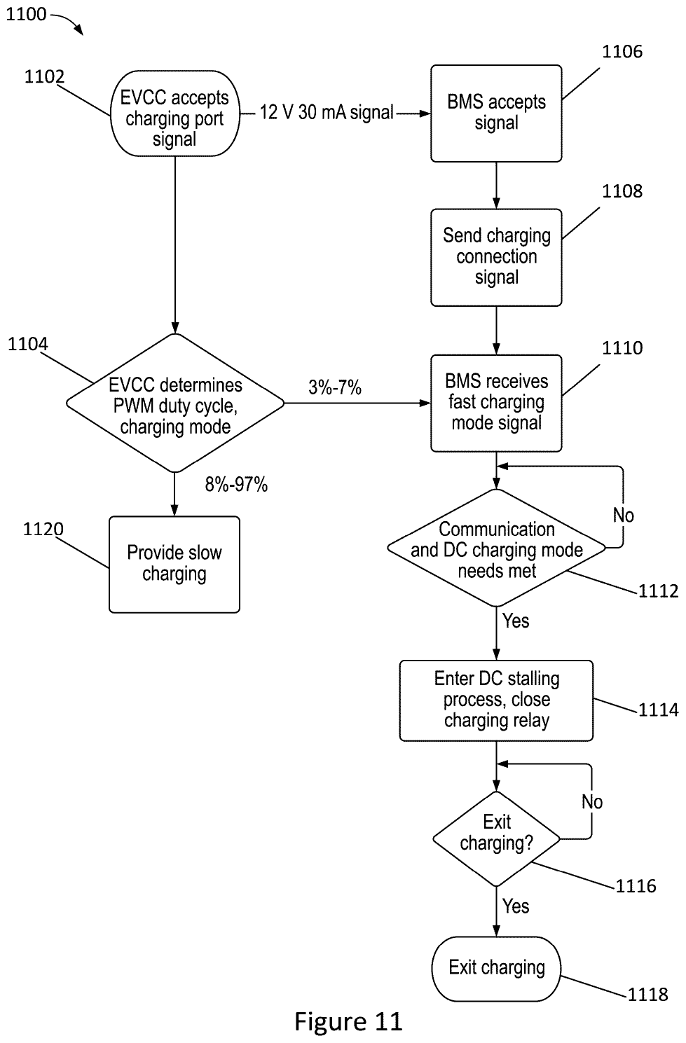

FIG. 11 illustrates a flow diagram illustrative of an implementations of a process 1100 of fast charging power-on and -off process of the PDU 102 mentioned herein. At step 1102, the EVCC 118 of the PDU 102 accepts a charging port signal from a charging source configured to provide power via fast charging port 108 and/or slow-charging port 110. The EVCC 118 can communicate between the BMS 502 and the charging station. The EVCC 118 can be responsible for managing the charging process and ensuring that the electronic vehicle is safely and efficiently charged. The EVCC 118 can contain a microprocessor, memory, and communication interfaces that allow it to communicate with the BMS 502 and the charging station using various communication protocols such as CAN (Controller Area Network), Ethernet, or Wireless communication protocols. The EVCC 118 can also monitor and control the power transfer between the charging station and the BMS 502, ensuring that the charging process is safe and efficient. The EVCC 118 can perform several functions, including: verifying the identity of the electronic vehicle and the charging station so that only authorized users are allowed to charge the vehicle; managing the charging process and control the amount of power transferred between the charging station and the electric vehicle so that the charging process is safe, efficient, and meets the requirements of both the electronic vehicle and the charging station; and communicate between the electronic vehicle and the charging station, including monitoring the charging status and providing feedback to the user. Thus, the charging port signal in step 1102 communicates to the BMS 502 to wake up and begin a charging cycle.

At step 1104, the EVCC 118 verifies a pulse-width modulation (PWM) generated by the charging station and a duty cycle measuring the charging port signal to determine the maximum charging current supported by the charging station (i.e., a high duty cycle represents a higher available charging current). Pulse Width Modulation (PWM) is a method of controlling the amount of power delivered to a load by varying the duration of a series of on/off pulses. The duty cycle is a parameter that describes the percentage of time during which the PWM signal is “on” (i.e., delivering power to the load) versus “off” (i.e., not delivering power to the load). The duty cycle is expressed as a percentage and can range from 0% (no power delivered to the load) to 100% (full power delivered to the load). For example, if the PWM signal has a frequency of 1 kHz and a duty cycle of 50%, the signal will be “on” for 500 microseconds (half of the period of the signal) and “off” for the remaining 500 microseconds. The duty cycle parameter in PWM applications can determine the average power delivered to the load. A higher duty cycle results in a higher average power, while a lower duty cycle results in a lower average power. The duty cycle during fast charging for an electric vehicle refers to the percentage of time that the battery is being charged at a high rate of power, typically from a DC fast charging station. This duty cycle is typically between 3% to 7% percent because fast charging can generate a lot of heat, which can cause damage to the battery if it is charged at a high rate for an extended period of time. During fast charging, the battery is can be charge using a high-power DC current, which can charge the battery to 80% or more in less than an hour, depending on the battery capacity and the charging infrastructure used. However, the charging rate typically decreases as the battery approaches its maximum capacity, in order to prevent overheating and damage to the battery. Thus, if the duty cycle is within 3% to 7%, the process 1100 continues to step 1110 and a fast-charging signal is sent to the BMS 502. However, if the duty cycle is between 8% to 97%, the process 1100 continues to step 1120 and a slow-charging signal is sent to the BMS 502.

At step 1106, the BMS 502 accepts the charging port signal from the EVCC 118. The charging port signal can be a 12-volt 30 milliamperes signal. The EVCC 118, PDU 102, and/or BMS 502 can communicate to provide information about the charging process and the state of the battery. The information can include: communicating the current charging status of the battery modules 104 between EVCC 118, PDU 102, and/or BMS 502, including the charging voltage, charging current, and the SOC of the battery; the scheduled start and end times for the charging process between EVCC 118, PDU 102, and/or BMS 502, allowing the EVCC 118, PDU 102, and/or BMS 502 to plan the battery charging and discharging cycles; communicating the temperature of the battery modules 104 between EVCC 118, PDU 102, and/or BMS 502, allowing the EVCC 118, PDU 102, and/or BMS 502 to monitor and manage the battery module's 104 thermal performance during the charging process; and communicating any errors or faults that occur during the charging process to the EVCC 118, PDU 102, and/or BMS 502, allowing the EVCC 118, PDU 102, and/or BMS 502 to take corrective action to ensure the safety and reliability of the charging process. The communication between the EVCC 118, PDU 102, and/or BMS 502 can ensure the safe and efficient charging of electric vehicles, allowing the EVCC 118, PDU 102, and/or BMS 502 to monitor and manage the battery's performance and ensuring that the charging process is optimized for maximum efficiency and longevity of the battery.

At step 1108, after the BMS 502 accepts the charging port signal, the BMS 502 communicates a charging connection signal. The charging connection signal of Step 1108 can also initiate step 1302 pf process 1300.

At step 1110, if the duty power is between 3% to 7%, the BMS 502 receives a fast-charging mode signal from the EVCC 118 and/or PDU 102.

At step 1112, the EVCC 118, the PDU 102, and/or BMS 502 determines whether communication protocols are satisfied and if fast-charging mode needs are met. If the fast-charging mode needs are not met, the EVCC 118, PDU 102, and/or BMS 502 repeats step 1112. If the charging needs are met, the PDU 102 enters a fast-charging communication and charging process, closes the charging relays, and sends a charging demand.

At step 1114, the EVCC 118 and/or PDU 102 determines whether to exit the charging process 1100. For example, the EVCC 118 and/or PDU 102 can detect that the charger has been disconnected and/or an error has been detected, that there is a change in the charging state (e.g., when the electric vehicle is no longer connected to the charging station), than an emergency shutdown was detected, and/or that an invalid PWM state requires disconnecting the charging source. In that case of a premature exit, process 1100 is to be repeated.

At step 1116, if the EVCC 118 and/or PDU 102 determines whether to exit the fast-charging process. The EVCC 118 and/or PDU 102 may determine that an error has occurred, that the charger was removed from the DC and/or AC charging port, that the one or more battery modules 104 are charged to a predetermined level, and/or that the one or more battery modules 104 are fully charged.

At step 1120, if the duty power is between 8% to 97%, the BMS 502 receives a slow-charging mode signal from the EVCC 118 and/or PDU 102.

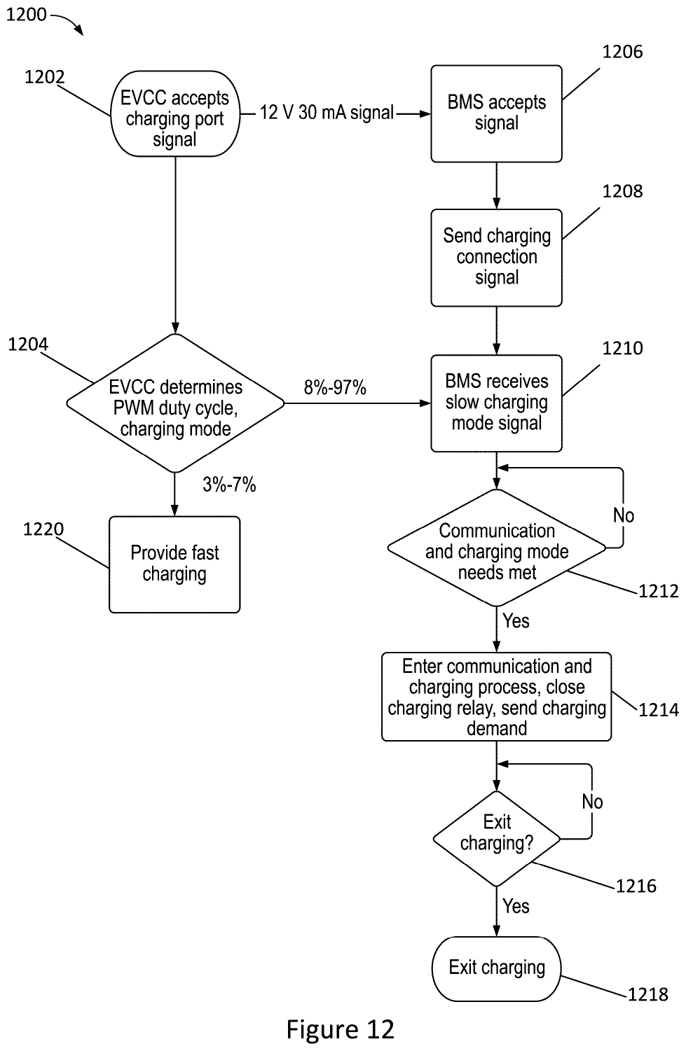

FIG. 12 illustrates a flow diagram illustrative of an implementations of a process 1200 of slow-charging power-on and -off process of the PDU 102 mentioned herein. The process 1200 can be similar and/or identical to process 1100 except for step 1204 in process 1200. At step 1204, if the duty cycle is between 8% to 97%, the process 1200 continues to step 1210 and a slow-charging signal is sent to the BMS 502. However, if the duty cycle is between 3% to 7%, the process 1200 continues to step 1220 and a fast-charging signal is sent to the BMS 502. Step 1202 can correspond to step 1102. Step 1206 can correspond to step 1106. Step 1208 can correspond to step 1108. The charging connection signal of Step 1208 can also initiate step 1302 pf process 1300. Step 1210 can correspond to step 1110. Step 1212 can correspond to step 1112. Step 1214 can correspond to step 1114. Step 1216 can correspond to step 1116. Step 1218 can correspond to step 1118.

At step 1210, if the duty power is between 8% to 97%, the BMS 502 receives a slow-charging mode signal from the EVCC 118 and/or PDU 102.

At step 1220, if the duty power is between 3% to 7%, the BMS 502 receives a fast-charging mode signal from the EVCC 118 and/or PDU 102.

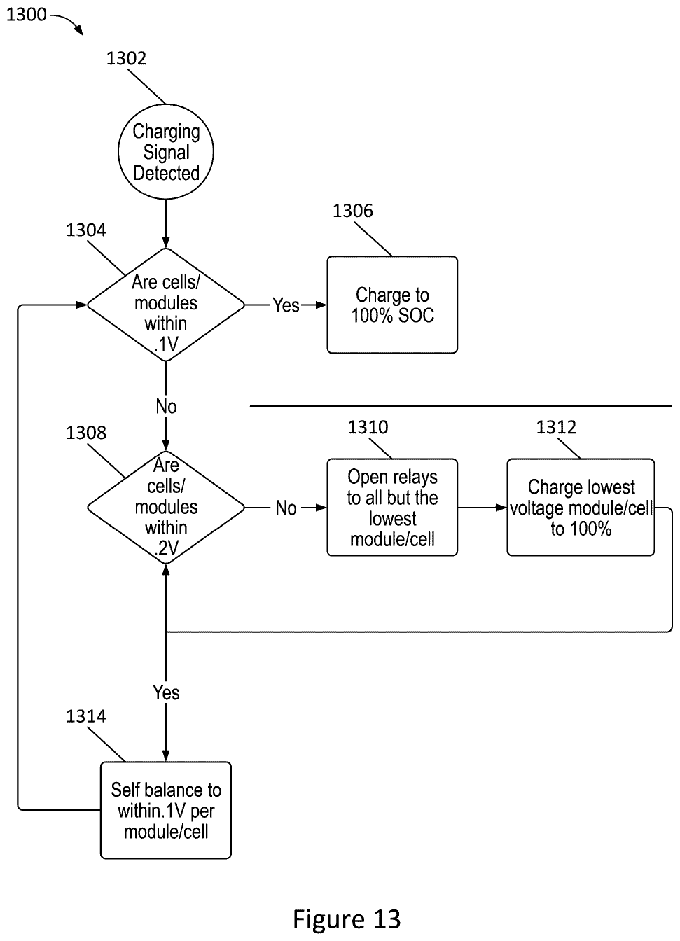

FIG. 13 illustrates a flow diagram illustrative of an implementations of a process 1300 to safely self-balance the one or more battery modules 104 during charging. The process 1300 can occur during fast-charging and/or slow-charging processes. The process 1300 can balance the one or more battery modules 104 of the modular battery system 100 when, for example, the one or more battery modules 104 have been connected and/or disconnected from the PDU 102. Additionally or alternatively, process 1300 can be performed when additional one or more battery modules 104 are added to and/or subtracted from the modular battery system 100. The process 1300 can be performed for battery modules 104 that are parallel electrical communication. The process 1300 can be performed for battery cells 112 that are parallel electrical communication. The self-balancing of the one or more battery modules 104 can correlate to the voltages of the one or more battery modules 104. The process 1300 can extend the life of the one or more battery modules 104 by preventing or minimizing the overcharging of the one or more battery modules 104. By charging the lowest charged battery module and/or battery cells 112, then remaining of the one or more battery modules 104 and/or battery cells 112, the health of the one or more battery modules can be extended. There are several methods for balancing cells in a battery pack. One method of balancing the battery modules 104 can be passive balancing, which involves using resistors to equalize the voltage of each cell in the battery module 104. In passive balancing, the resistors are connected in parallel with each battery cell 112, and they draw current from the battery cells 112 that have a higher voltage. This allows the battery cells 112 with a lower voltage to charge up, and, eventually, all battery cells 112 in the battery module 104 can have the same voltage. Another balancing method can be active balancing, which involves using a balancing circuit to actively transfer charge between battery cells 112 in the battery module 104. In active balancing, the balancing circuit monitors the voltage of each battery cell 112 in the battery module 104 and transfers charge from battery cells 112 with a higher voltage to battery cells 112 with a lower voltage. This helps to equalize the SOC and voltage of each battery cell 112 in the battery module 104.

Further, errors during operation and discharge can be minimized by having balanced battery modules powering the system. For example, by maintaining similar health and SOC of the battery modules, individual battery module failures (e.g., Level 3 fault as discussed herein) may occur less and the battery system may function longer without maintenance and/or battery module swaps. Individual battery module failure can include one battery module failing, while the other battery modules are functional. One battery module failure may require shutting down the system and swapping the failed battery module while the rest of the battery modules are functional. Mitigating or minimizing the individual battery module failure via balanced charging as discussed herein can then lead to more dependable and longer performance of the battery system.

At step 1302, the process can begin when a charging signal is detected by the EVCC 118. Discussion herein with respect to battery cells 112 can be performed by the BMS 502. Discussion herein with respect to the battery modules 105 can be performed by the PDU 102. At step 1304, the BMS 502 and/or PDU 102 can determine voltage level differences within the battery cells 112 of the one or more battery modules 104 and/or of the battery modules 104. The BMS 502 and/or PDU 102 can monitor the SOC of the plurality of battery cells 112 of each of the one or battery modules and/or of the one or more battery modules 104 and determine whether to charge or not charge any of the plurality of cells 112 and/or the one or more battery modules 104 based at least on the voltage level detected. If the voltage difference is within 0.1 volts, the process 1300 continues to step 1306. Other values can include if the voltage difference is within 0.2 volts, within 0.3 volts, within 0.4 volts, within 0.5 volts, withing a range from 0.1 volts to 1 volt, within a range from 0.1 volts to 0.75 volts, within a range of 0.1 volts to 0.5 volts, withing a range of 0.1 volts to 0.4 volts, within a range of 0.1 volts to 0.3 volts, or within a range of 0.1 volts to 0.2 volts.

If the difference between the battery cells 112 of the one or more battery modules 104 are not within 0.1 volts or the other values discussed above, then the process 1300 continues to step 1308. The voltage values and/or ranges can be increased by one or two magnitudes depending on the system requirements. For example, the PDU 102 may determine that battery modules 1-3 are within 0.1 volts of one another and a battery module 4 may have a voltage differential of 0.4 volts (i.e., falls out of a designated range of a voltage differential of 0.1 volts) and the lowest voltage level.

At step 1306, the BMS 502 and/or PDU 102 instructs that the plurality of cells 112 of all of the one or more battery modules 104 and/or the battery modules 104 are charged to 100% SOC. The process 1300 then ends once step 1306 is complete. In a second example, if the battery modules 1-4 have a voltage differential of 0.1 (falling within the designated range), then the battery modules 1-4 are charged to 100% SOC.

At step 1308, the BMS 502 and/or PDU 102 determines if the voltage level difference of the plurality of cells 112 of the one or more battery modules 104 and/or the battery modules 104 are within 0.2 volts. Other values can include if within 0.3 volts, within 0.4 volts, within 0.5 volts, withing a range from 0.2 volts to 1 volt, within a range from 0.2 volts to 0.75 volts, within a range of 0.2 volts to 0.5 volts, withing a range of 0.2 volts to 0.4 volts, within a range of 0.2 volts to 0.3 volts, or within a range of 0.2 volts to 0.25 volts.

If the plurality of cells 112 of the one or more battery modules and/or the battery modules 104 are not within 0.2 or the other values discussed above, the process 1300 continues to step 1310. If the voltage level difference is within 0.2 volts or the other values discussed above, the process 1300 continues to step 1314. The voltage values and/or ranges can be increased by one or two magnitudes depending on the system requirements. As mentioned in the first example, the PDU 102 may determine that battery modules 1-3 are within 0.1 volts of one another and a battery module 4 may have a voltage differential of 0.4 volts and the lowest voltage level.

At step 1310, the charging relays 805 of PDU 102 can be switched to an open position for all but the plurality of battery cells 112 of the one or more battery modules 104 and/or the one or more battery modules 104 having the lowest voltage level. For example, one or more relays can be closed for charging the battery module 4, which also has the lowest voltage. The relays connected to the battery modules 1-3 can be in an open state to prevent any charging of said modules 1-3. For battery cells 112, a similar protocol may be implemented with charging relays switched to an open position for all but the plurality of battery cells 112 of the one or more battery modules 104 having the lowest voltage level.

At step 1312, the plurality of battery cells 112 and/or the one or more battery modules 104 having the lowest voltage level is charged to a SOC of 100%. Step 1308 can then be repeated until the plurality of cells 112 of the one or more battery modules 104 and/or the one or more battery modules 104 are within 0.2 volts or the other value discussed above. The voltage values and/or ranges can be increased by one or two magnitudes depending on the system requirements. Once the BMS 502 determines that the plurality of cells 112 of the one or more battery modules 104 and/or the one or more battery modules are within the designated range, the process 1300 proceeds to step 1314. Continuing with the example above, the PDU 102 can then cause the battery module 4 to be charged to 100% SOC since the battery module 4 had the lowest voltage. The BMS 502 can cause a battery cell to be charged to 100% SOC that had the lowest voltage. Step 1312 provides charger (external power source) driven balancing of the battery modules 104 that are in parallel electrical communication and/or battery cells 112 that are in parallel electrical communication.

At step 1314, the BMS 502 and/or PDU 102 can balance or self-balance the plurality of cells 112 of the one or more battery modules 104 and/or the one or more battery modules 104 until all of the plurality of cells 112 and/or the one or more battery modules 104 are within 0.1 volts of each other. For example, the BMS 502 and/or PDU 102 can charge multiple battery cells 112 of the one or more battery modules 104 and/or multiple the one or more battery modules 104 until all of the plurality of cells 112 and/or all the one or more battery modules 104 are within 0.1 volts of each other. Once all of the plurality of cells 112 and/or the one or more battery modules 104 are within 0.1 volts, the process 1300 proceeds to step 1304. At 1304, the BMS 502 and/or PDU 102 determines whether the plurality of cells 112 and/or the one or more battery modules 104 are within 0.1 volts to proceed to step 1306. At step 1306, the plurality of cells 112 and/or the one or more battery modules 104 can be charged to 100% SOC. Step 1306 provides passive self balancing of the battery modules 104 that are in parallel electrical communication and/or battery cells 112 that are in parallel electrical communication.

The SOC of the one or more battery modules 104 can be calculated from the SOC equations below. The SOC equations are a mathematical representation of the amount of energy stored in a battery as a percentage of its total capacity. Calculating SOC (i.e., charge remaining) at various intervals during discharge can be expressed in Equation 1 as:

$$SOC ( t ) = \frac{{Q}_{r}}{{Q}_{c}} \times 100 \%$$

where SOC is the state of charge expressed as a percentage (between 0% and 100%) at a certain time, Q_{c} is the total capacity of the battery when fully charged, and Qᵣ is the total capacity of the battery remaining at a certain time interval. Equation 1 can further be expressed in Equation 2 as:

$$SOC ( t ) = \frac{{Q}_{c} - {Q}_{f}}{{Q}_{c}} \times 100 \%$$

where Q_{f} is the capacity of the battery used over a time period. The calculation of Qt can be expressed in Equation 3 as:

$${Q}_{f} = \int Idt$$

where ∫Idt is the integral of the current flowing into or out of the battery over time. Lastly, combining the equations above can result in Equation 4 expressed below as:

$$SOC ( {t}_{1} ) = S O C ( {t}_{0} ) + \frac{{\int }_{{t}_{0}}^{{t}_{1}} i ( t ) dt}{{Q}_{c}}$$

The SOC equation assumes that the battery is behaving ideally, meaning that there is no self-discharge or other losses that would affect its capacity. In practice, however, batteries can lose capacity over time due to a variety of factors, including temperature, age, and usage patterns. Therefore, the actual SOC of a battery may differ from what is predicted by the equation.

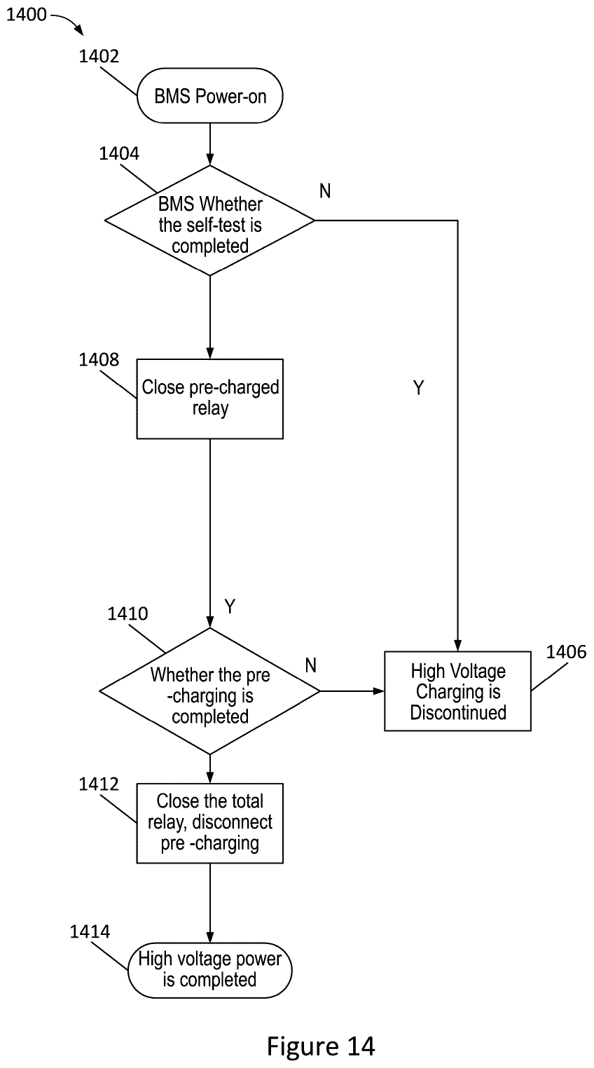

FIG. 14 illustrates a flow chart of a process 1400 of a high-voltage power on process of charging the one or more battery modules 104. The process 1400 can be performed by the modular battery system 100. At step 1402, the process 1400 begins with the BMS 502 powering on. At step 1404, the BMS 502 performs a self-test to determine whether a desired or predetermined fast-charging protocol signal and/or slow-charging protocol signal is detected. If the self-test is not completed, the process 1400 continues to step 1406. If the self-test is completed, the process 1400 continues to step 1408. At step 1406, the BMS 502 and/or PDU 102 discontinues the high-voltage charging. The process 1400 may then be repeated until some or all conditions of the self-test and/or pre-charging process are satisfied.

At step 1408, the PDU 102 closes the pre-charge relays 804 to gradually charge the capacitors 828 of the system until full. This process is for protecting the electronic components and the one or more battery modules 104 from damage that could result from a sudden surge of current when the system is energized. In addition to the pre-charge relays 804, the circuit can include the pre-charge resistors 802. As mentioned herein, the pre-charge resistors 802 limits the amount of current that flows into the capacitors 828, while the pre-charge relays 804 gradually closes to allow current to flow into the capacitors 828. As current flows into the capacitors 828, they slowly charge up to the appropriate voltage level. This process may take a few seconds, depending on the size of the capacitors and the amount of current being used.

At step 1410, the PDU 102 determines whether the pre-charging is complete by determining whether the capacitors 828 electrically connected to the pre-charge relays 804 are fully charged. If the pre-charging process of step 1408 is not complete, the process 1400 proceeds to step 1406. If the pre-charging process of step 1408 is complete, the process 1400 proceeds to step 1412. At step 1412, the PDU 102 closes the charging relays 805 and disconnects the pre-charge relays 804. Once the capacitors 828 are fully charged at step 1410, the pre-charge relays 804 opens and the charging relays 805 in the vehicle's electrical system closes, allowing full power to flow to the motor 124 and other subsystems. At step 1414, the process 1400 ends.

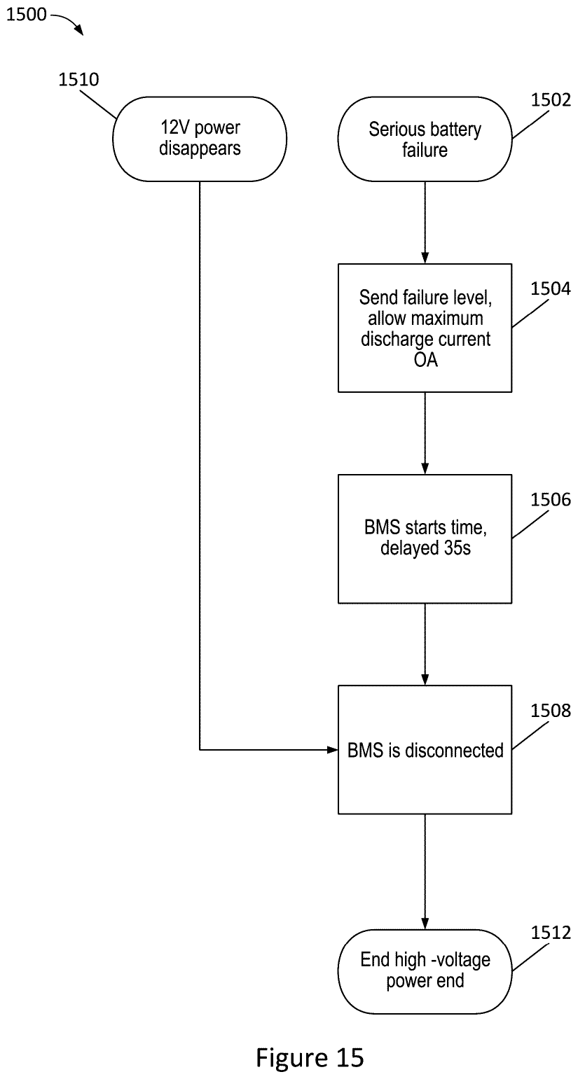

FIG. 15 illustrates a flow chart of a process 1500 of a high-voltage power off process of the one or more battery modules 104 during a battery failure. The process 1500 can be performed by the BMS 502 and/or PDU 102. At step 1502, the BMS 502 detects a serious battery failure. The BMS 502 and/or PDU 102 can continuously monitor the one or more battery modules 104 of potential battery issues. The BMS 502 and/or PDU 102 can continuously monitor the voltage, temperature, current, SoC, and battery health of the one or more battery modules 104 to determine that the one or more battery modules 104 are operating safely and efficiently. Table 5 provides examples of potential battery failures and the seriousness level corresponding to each failure. A Level 1 fault can generate an alarm to provide a notification of the failure. A Level 2 fault can generate an alarm and limit the charge and discharge power to 50% of the current allowable value from the charging source. A Level 3 fault can generate an alarm and limit the charge and discharge power to 0% of the current allowable value from the charging source, disconnect any high voltage sources, and/or some functions may be restored after the BMS 502 is restarted. For example, in some implementations, a voltage differential greater than 500 mV (SOC<95%) can trigger a Level 2 battery fault. In some implementations, if the voltage differential is less than 400 mV, the batteries may enter a recovery mode. The Battery Faults of Table 5 can include different alarms and/or devices depending on the parameters monitored. For example, a monomer voltage alarm can monitor the voltage of one of the one or more battery modules 104 and/or of one cell of the plurality of cells 112 to determine the voltage of the battery module 104 and/or battery cell 112. An electric under voltage alarm can be a device to alert users when the voltage in the system 100 drops below a certain level. When the voltage drops below a pre-set threshold, the alarm will sound, indicating that the system 100 may be in danger of malfunctioning or failing. Electric under voltage alarms can be used in industrial settings where a sudden drop in voltage can cause damage to equipment or interrupt critical processes. Electric under voltage alarms can also be used in residential and commercial settings to monitor voltage levels and alert users of potential electrical problems. Some electric under voltage alarms may also have visual indicators and/or digital displays that provide information about the voltage levels in the modular battery system 100 to quickly identify and address any issues before serious harm occurs. A total voltage over voltage can monitor the voltage levels in the modular battery system 100 and alert users when the voltage rises above a certain level. A total voltage under voltage alarm can to monitor the voltage levels in the system 100 and alert users when the voltage falls below a certain level. When the voltage exceeds a preset threshold, the alarm will sound, indicating that the system may be in danger of malfunctioning or failing.

The Total Voltage Over Voltage alarm can be an ordinary string number and the Total Voltage Under Voltage alarm can be an intranet/internal alarm.

TABLE 5
Battery Fault Thresholds

| | | Troubleshooting | | |
|---|---|---|---|---|
| | | strategy: the | | |
| | | vehicle shall be | | |
| | Fault | charged and | | |
| | level | discharged | | |
| | (Level 3 | according to the | | Duration of |
| | is the | allowable | Monitored | Alarm |
| Fault description | highest) | battery power. | Parameter | (Seconds) |
| Monomer over | 3 | The feedback | Alarm threshold: | 5 |
| voltage alarm | | current is | 3.75 Volts (V) | |
| | | limited to 0, and | / | |
| | | the relay is | | |
| | | disconnected | | |
| | | after a delay of | | |
| | | 35 second | | |
| Electric under | 2 | Allow the | Alarm threshold: | 5 |
| voltage alarm | | discharge | 2.8 V | |
| | | current to drop | Cancellation | |
| | | to 50% | threshold: 3.0 V | |
| Monomer over- | 3 | Allow the | Alarm threshold: | 5 |
| discharge alarm | | discharge | 2.5 V | |
| | | current to drop | / | |
| | | to 0, and delay | | |
| | | 35 second to | | |
| | | break the relay. | | |
| Monomer | 2 | Intranet alarm | Alarm threshold: | 5 |
| Voltage | | only | 0.500 V. | |
| difference alarm | | | Cancellation | |
| (when State of | | | threshold: 0.400 V | |
| Charging <95%) | | | | |
| Total Voltage | 3 | The feedback | Alarm threshold: | 5 |
| Over Voltage | | current is | Battery Voltage ≥3.75 | |
| Alarm | | limited to 0, and | V*N, where N | |
| | | the relay is | is the total number | |
| | | disconnected | of battery strings | |
| | | after a delay of | / | |
| | | 35 seconds | | |
| Total Voltage | 3 | Allow the | Alarm threshold: | 5 |
| Under Voltage | | discharge | Battery Voltage <2.5*N, | |
| Alarm | | current to drop | where N | |
| | | to 0, and delay | is the total number | |
| | | 35 seconds to | of battery strings | |
| | | break the relay | Cancellation | |
| | | | threshold: Battery | |
| | | | Voltage >2.8*N + | |
| | | | 3, where | |
| | | | N is the total | |
| | | | number of battery | |
| | | | strings | |
| Battery High | 3 | Allow the | Alarm threshold: | 5 |
| Temperature | | charging and | 60° C. | |
| Alarm | | discharging | / | |
| | | current to drop | | |
| | | to 0 and delay | | |
| | | the relay for 35 | | |
| | | seconds | | |
| Excessive | 3 | The feedback | Alarm threshold: | 5 |
| Recharge | | current is | 120% of the | |
| Current of | | limited to 0, and | current allowable | |
| Battery | | the relay is | value | |
| | | disconnected | / | |
| | | after a delay of | | |
| | | 35 S. | | |
| Excessive | 3 | Allow the | Alarm threshold: | 5 |
| Battery | | discharge | 120% of the | |
| Discharge | | current to drop | current allowable | |
| Current | | to 0, and delay | value | |
| | | 35 S to break the | / | |
| | | relay. | | |
| BMS Internal | 1 | Intranet alarm | Alarm threshold: | 5 |
| Communication | | | internal | |
| Fault Alarm | | | communication | |
| | | | failure. | |
| | | | Cancel threshold: | |
| | | | communication | |
| | | | recovery | |
| Charging Gun | 3 | Intranet alarm | Alarm threshold: | 5 |
| Temperature | | stops charging. | charging gun | |
| Alarm | | | temperature >120° C. | |
| | | | / | |
| | 2 | The required | Alarm threshold: | 5 |
| | | charging current | charging gun | |
| | | is 60%. | temperature >80° C. | |
| | | | Cancellation | |
| | | | threshold: | |
| | | | charging gun | |
| | | | temperature <75° C. | |
| | 1 | The required | Alarm threshold: | 5 |
| | | charging current | charging gun | |
| | | is 80%. | temperature >60° C. | |
| | | | Cancellation | |
| | | | threshold: | |
| | | | charging gun | |
| | | | temperature <55° C. | |
| 12 V Abnormal | 1 | Intranet alarm | Alarm | 5 |
| power supply | | | threshold: <9 V | |
| | | | Cancellation | |
| | | | threshold: ≥12 V | |
| State of Charge | 1 | Intranet alarm | Alarm threshold ≥10% | 5 |
| (SOC) is too low | | | | |
| (%) | | | | |

At step 1504, the BMS 502 can transmit a battery failure signal to the BMU 814 of the PDU 102. The BMS 502 and/or PDU 102 can set the maximum allowable discharge current to 0 A. The PDU 102 can send a signal to power off the modular battery system 100. The one or more battery modules 104 can then be analyzed by the BMU 814 according to the fault level. When the voltage of the one or more battery modules 104 is reduced to the set threshold during the discharge process, the BMU 814 may issue fault prompts such as low monomer voltage, low total voltage, and/or low SOC.

At step 1506, the BMS 502 and/or PDU 102 can trigger and/or set a timer in which to reevaluate the status of the battery failure after the timer lapses. The timer can be set for a maximum of 180 seconds, a maximum of 120 seconds, a maximum of 105 seconds, a maximum of 90 seconds, a maximum of 75 seconds, a maximum of 60 seconds, a maximum of 50 seconds, a maximum of 45 seconds, a maximum of 40 seconds, a maximum of 35 seconds, a maximum of 30 seconds, a maximum of 25 seconds, a maximum of 20 seconds, or a maximum of 15 seconds.

At step 1508, at the end of the timer, if the BMS 502 and/or PDU 102 continues to detect the battery failure, the BMS 502 and/or PDU 102 can disconnect the failed one or more battery modules 104, including the corresponding BMS 502. At step 1510, the BMS 502 and/or PDU 102 can disconnect the failed one or more battery modules 104, including the corresponding BMS 502 if 12-volt power is detected to not be present. Step 1508 can include disconnecting or shutting down the system 100 entirely. At step 1512, the process 1500 ends with the system 100 disconnected or shut down to no longer provide high-voltage power from the one or more battery modules 104.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, user interfaces, and algorithm steps described in connection with the embodiments disclosed herein can be implemented as electronic hardware, or combinations of electronic hardware and computer software. To illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks, user interfaces, and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. A processor can be a hardware processor, which can be one or more hardware processors (e.g., MMU 504 and/or BMU 814), configured to execute one or more instructions stored in memory to cause the system to perform the methods, processes, routines, functions, and/or algorithms discussed herein. A memory can store specific computer-executable instructions. The memory can be one or more memories, including one or more non-transitory memories, associated with each of the one or more hardware processors (e.g., MMU 504 and/or BMU 814). A hardware processor in communication with the memory can execute the specific computer-executable instructions to perform the methods, processes, routines, functions, and/or algorithms discussed herein. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device (controller), or in a combination of the two, that command, control, or cause the system(s) and associated components described herein to perform one or more functions or features of the method, process, routine, or algorithm. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

As an example, a computer system may be implemented in the various embodiments in the described subject matter. The computer system can include a processor, main memory, storage, a bus, and input. The processor may be one or more processors. The processor executes instructions that are communicated to the processor through the main memory. The main memory feeds instructions to the processor. The main memory is also connected to the bus. The main memory may communicate with the other components of the computer system through the bus. Instructions for the computer system are transmitted to the main memory through the bus. Those instructions may be executed by the processor. Executed instructions may be passed back to the main memory to be disseminated to other components of the computer system. The storage may hold large amounts of data and retain that data while the computer system is unpowered. The storage is connected to the bus and can communicate data that the storage holds to the main memory through the bus.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

Several illustrative examples of testing elements for bonded structures and related systems and methods have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps may be arranged or performed differently than described and components, elements, features, acts, or steps may be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations may also be implemented in combination in a single implementation. Conversely, various features that are described in the context of a single implementation also may be implemented in multiple implementations separately or in any suitable subcombination. Moreover, although features may be described above as acting in certain combinations, one or more features from a claimed combination may in some cases be excised from the combination, and the combination may be claimed as a subcombination or variation of a subcombination.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures may or may not be drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various examples may be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures. or description herein. For example, various functionalities provided by the illustrated modules may be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification may be included in any example.

1.-87. (canceled)

88. A vehicle modular battery system configured to charge at least two battery modules, the system comprising:
at least two battery modules each comprising a plurality of battery cells configured to store electric energy;
a power distribution unit comprising:
a first electrical interface configured to connect to an external energy source for delivering electric power to the power distribution unit from the external energy source;
a second electrical interface configured to connect to an electric motor of a vehicle for delivering electric power to the electric motor from the power distribution unit; and
a third electrical interface configured to connect to the at least two battery modules for delivering electric power to the at least two battery modules from the power distribution unit and delivering electric power to the power distribution unit from the at least two battery modules;
a non-transitory memory configured to store specific computer-executable instructions; and
a hardware processor in communication with the non-transitory memory and configured to execute the specific computer-executable instructions to at least:
determine that the at least two battery modules are within a first voltage range of each other;
in response to determining that the at least two battery modules are within the first voltage range of each other, cause the power distribution unit to charge the at least two battery modules to a 100% state of charge using electric power from the external energy source;
determine that the at least two battery modules are not within the first voltage range of each other;
in response to determining that the at least two battery modules are not within the first voltage range of each other, determine that the at least two battery modules are not within a second voltage range of each other, the second voltage range greater than the first voltage range;
in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source;
determine that the at least two battery modules are within the second voltage range of each other; and
in response to determining that the at least two battery modules are within the second voltage range of each other, cause the power distribution unit to charge the at least two battery modules using electric power from the external energy source to change states of the at least two battery modules to be within the first voltage range of each other.

89. The system of claim 88, wherein the at least two battery modules comprise at least three battery modules, and wherein the hardware processor is further configured to execute the specific computer-executable instructions to at least, in response to determining that the at least two battery modules are within the second voltage range of each other, cause the power distribution unit to charge at least a first and a second battery module of the at least three battery modules using electric power from the external energy source to change states of the at least three battery modules to be within the first voltage range of each other.

90. The system of claim 89, wherein the at least the first and the second battery module have lowest voltages relative to the other battery modules of the at least three battery modules.

91. The system of claim 88, wherein the power distribution unit further comprises a fourth electrical interface configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

92. The system of claim 88, wherein the first electrical interface is configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data, wherein the external energy source comprises at least one of a fast-charging source or a slow-charging source, the fast-charging source comprising a direct current energy source and the slow-charging source comprising an alternating current source, and wherein the hardware processor is further configured to execute the specific computer-executable instructions to at least determine whether the fast-charging source or the slow-charging source is connected to the first electrical interface.

93. The system of claim 88, wherein the power distribution unit further comprises a fifth electrical interface configured to communicate electric motor data to the hardware processor, wherein the second electrical interface and the fifth electrical interface are configured to communicate electric motor data to the hardware processor, the electric motor data associated with operating variables of the electric motor, wherein the hardware processor is further configured to execute the specific computer-executable instructions to at least determine electric power delivery protocols to the electric motor based on the electric motor data, and wherein the second or fifth electrical interface is configured to communicate with a motor controller to receive the electric motor data, the motor controller configured to control operation of the electric motor.

94. The system of claim 88, wherein the power distribution unit further comprises a sixth electrical interface, wherein the third electrical interface and the sixth electrical interface are configured to communicate battery module data to the hardware processor, the battery module data associated with operating variables of the at least two battery modules, wherein the hardware processor is further configured to execute the specific computer-executable instructions to at least determine electric power delivery protocols between the power distribution unit and the at least two battery modules based on the battery module data, and wherein the third or sixth electrical interface is configured to communicate with a module management unit to receive the battery module data, the module management unit configured to control operation of one of the at least two battery modules.

95. The system of claim 88, wherein the hardware processor is further configured to execute the specific computer-executable instructions to at least:
receive a charging port signal from the external energy source;
determine a pulse-width modulation and duty cycle from the charging port signal; and
determine a maximum charging current to be delivered by the external energy source from the pulse-width modulation and duty cycle.

96. The system of claim 95, wherein the hardware processor is further configured to execute the specific computer-executable instructions to at least determine whether to charge the at least two battery modules using a fast-charging protocol or a slow-charging protocol based on the pulse-width modulation and duty cycle.

97. The system of claim 96, wherein the hardware processor is further configured to execute the specific computer-executable instructions to at least determine to charge the at least two battery modules using the fast-charging protocol based on a duty cycle of 3% to 7%.

98. The system of claim 96, wherein the hardware processor is further configured to execute the specific computer-executable instructions to at least determine to charge the at least two battery modules using the slow-charging protocol based on a duty cycle of 8% to 97%.

99. A modular battery system configured to charge at least two battery modules, the system comprising:
at least two battery modules each comprising a plurality of battery cells configured to store electric energy;
a power distribution unit comprising:
a first electrical interface configured to connect to an external energy source for delivering electric power to the power distribution unit from the external energy source; and
a second electrical interface configured to connect to the at least two battery modules for delivering electric power to the at least two battery modules from the power distribution unit and delivering electric power to the power distribution unit from the at least two battery modules;
a non-transitory memory configured to store specific computer-executable instructions; and
a hardware processor in communication with the non-transitory memory and configured to execute the specific computer-executable instructions to at least:
determine that the at least two battery modules are within a first voltage range of each other;
in response to determining that the at least two battery modules are within the first voltage range of each other, cause the power distribution unit to charge the at least two battery modules to a 100% state of charge using electric power from the external energy source;
determine that the at least two battery modules are not within the first voltage range of each other;
in response to determining that the at least two battery modules are not within the first voltage range of each other, determine that the at least two battery modules are not within a second voltage range of each other, the second voltage range greater than the first voltage range;
in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source;
determine that the at least two battery modules are within the second voltage range of each other; and
in response to determining that the at least two battery modules are within the second voltage range of each other, cause the power distribution unit to charge the at least two battery modules using electric power from the external energy source to change states of the at least two battery modules to be within the first voltage range of each other.

100. The system of claim 99, wherein the at least two battery modules are connected to the power distribution unit in parallel.

101. The system of claim 100, wherein the power distribution unit is configured to switch connection of the at least two battery modules between parallel electrical connection or series electrical connection to the power distribution unit.

102. The system of claim 99, wherein the external energy source comprises at least two external energy sources, wherein the first electrical interface comprises at least two electrical interfaces, wherein each of the at least two electrical interfaces are configured to connect to a corresponding external energy source of the at least two external energy sources, and wherein the at least two external energy sources comprise a direct current charging source and an alternating current charging source.

103. The system of claim 99, wherein the second electrical interface comprises at least two electrical interfaces, wherein each of the at least two electrical interfaces are configured to connect to a corresponding battery module of the at least two battery modules.

104. The system of claim 99, wherein the second electrical interface is configured to connect to a varying number of battery modules of the at least two battery modules.

105. The system of claim 99, wherein the hardware processor is further configured to execute the specific computer-executable instructions to at least determine a number of battery modules of the at least two battery modules connected to the second electrical interface.

106. A power distribution unit configured to charge at least two battery modules, the power distribution unit comprising:
a first electrical interface configured to connect to an external energy source for delivering electric power to the power distribution unit from the external energy source;
a second electrical interface configured to connect to at least two battery modules for delivering electric power to the at least two battery modules from the power distribution unit and delivering electric power to the power distribution unit from the at least two battery modules, the at least two battery modules each comprising a plurality of battery cells configured to store electric energy;
a non-transitory memory configured to store specific computer-executable instructions; and
a hardware processor in communication with the non-transitory memory and configured to execute the specific computer-executable instructions to at least:
determine that the at least two battery modules are within a first voltage range of each other; and
in response to determining that the at least two battery modules are within the first voltage range of each other, cause the power distribution unit to charge the at least two battery modules to a 100% state of charge using electric power from the external energy source.

107. The power distribution unit of claim 106, wherein the first electrical interface is configured to communicate external energy source data to the hardware processor, the external energy source data associated with operating variables of the external energy source, wherein the hardware processor is further configured to execute the specific computer-executable instructions to at least determine charging protocols for the at least two battery modules based on the external energy source data.

108. The power distribution unit of claim 106, wherein the hardware processor is further configured to execute the specific computer-executable instructions to at least receive a charging connection signal from each of the at least two battery modules indicating that the at least two battery modules are ready to be charged.

109. The power distribution unit of claim 106, wherein the first voltage range of the at least two battery modules being within 0.1 volts of each other.

110. The power distribution unit of claim 106, wherein the hardware processor is further configured to execute the specific computer-executable instructions to at least:
determine that the at least two battery modules are not within the first voltage range of each other;
in response to determining that the at least two battery modules are not within the first voltage range of each other, determine that the at least two battery modules are not within a second voltage range of each other, the second voltage range greater than the first voltage range;
in response to determining that the at least two battery modules are not within the second voltage range of each other, determine a battery module of the at least two battery modules that has a lowest voltage relative to the other battery modules of the at least two battery modules and cause the power distribution unit to charge the battery module with the lowest voltage to a 100% state of charge using electric power from the external energy source;
determine that the at least two battery modules are within the second voltage range of each other; and
in response to determining that the at least two battery modules are within the second voltage range of each other, cause the power distribution unit to charge the at least two battery modules using electric power from the external energy source to change states of the at least two battery modules to be within the first voltage range of each other.

111. The power distribution unit of claim 110, wherein the second voltage range of the at least two battery modules being within 0.2 volts of each other.
